(19) United States
(12) Patent Application Publication
(10) Pub. No.: US 2018/0067547 A1
(43) Pub. Date: Mar. 8, 2018

(54) VIRTUAL REALITY MOTION SIMULATION SYSTEM

(71) Applicant: RUSSELL-HAMPSON, INC., San Diego, CA (US)

(72) Inventors: Cody Thomas Russell, San Diego, CA (US); Tristan Andrew Hampson, Chula Vista, CA (US); Joshua Paul Smith, Escondido, CA (US); Thomas Miguel Lugo, III, San Diego, CA (US)

(21) Appl. No.: 15/696,038

(22) Filed: Sep. 5, 2017

Related U.S. Application Data
(60) Provisional application No. 62/384,099, filed on Sep. 6, 2016.
(60) Provisional application No. 62/467,042, filed on Mar. 3, 2017.

(51) Int. Cl. G06F 3/01; G06F 3/14; A42B 3/04

(52) U.S. Cl. CPC G06F 3/011; G06F 3/1454; G06F 3/013; G06F 3/012; A42B 3/042

(57) ABSTRACT

The present system includes a virtual reality headset helmet adaptor that retains a virtual reality headset against the face of a user when the user wears a helmet and the virtual reality headset. The adaptor is configured to be operated by the user to tighten the virtual reality headset against the face of the user. The system also facilitates selection of a virtual reality motion experience for presentation to the user via the virtual reality headset, and control commands related to starting and/or stopping such a presentation. The selection of information is performed by an operator using an operator control system that is located remotely from the virtual reality headset. The system also receives information from sensor output signals indicating body position, head position, and/or eye position of the user during the virtual reality motion experience, and adjusts the presentation of the virtual reality motion experience based on this information.

### CROSS-REFERENCE TO RELATED APPLICATIONS

This application incorporates by reference the contents of U.S. Provisional Patent Application No. 62/384,099 filed on Sep. 6, 2016 and entitled “SKYDIVING VIRTUAL REALITY SYSTEM” and U.S. Provisional Patent Application No. 62/467,042 filed on Mar. 3, 2017 and entitled “VIRTUAL REALITY MOTION SIMULATION SYSTEM” in their entireties.

### FIELD OF THE DISCLOSURE

The subject matter described herein relates to a system for providing a virtual reality experience, and in particular to providing a virtual reality experience where a user would normally wear a helmet for a corresponding physical version of the experience.

### BACKGROUND

Virtual reality headset display devices are known. These devices visually simulate a user's physical presence in virtual spaces. Simulations typically include a 360° view of the user's surrounding virtual space such that user may turn his head to view different portions of the surrounding space. Activity in the virtual space is controlled by the user and is typically not associated and/or coordinated with conditions and/or activity in the physical world surrounding the user.

### SUMMARY

One aspect of the present disclosure relates to a virtual reality headset helmet adaptor system and corresponding method. In some embodiments, the adaptor system comprises a headset holder, an anchor strap, an anchor bracket, a tightening strap, a tightening bracket, a tightener, and/or other components. The headset holder may be configured to couple with a helmet and removably retain a virtual reality headset against the face of a user such that virtual reality images displayed by the virtual reality headset remain viewable by the user when the user wears the helmet and the virtual reality headset. The anchor strap may be coupled to a first side of the headset holder at or near a first end of the anchor strap. The anchor bracket may be coupled to a corresponding first side of the helmet and configured to receive and engage a second end of the anchor strap to anchor the headset holder to the helmet via the anchor strap. The tightening strap may be configured to removably couple with a second side of the headset holder at or near a first end of the tightening strap. The tightening bracket may be coupled to a corresponding second side of the helmet configured to receive and engage a second end of the tightening strap. The tightener may be coupled to the second side of the headset holder and configured to be operated by the user to removably couple the tightening strap with the second side of the headset holder by causing the tightening strap to pass through the tightener in a tightening direction such that the headset holder to engages the virtual reality headset and retains the virtual reality headset against the face of the user when the user wears the helmet and the virtual reality headset.

In some embodiments, the headset holder comprises an internal structural member comprising a fracture-resistant frame configured to surround an outer edge of the virtual reality headset when the headset holder retains the virtual reality headset against the face of the user to support the virtual reality headset in alignment with eyes of the user. In some embodiments, the headset holder comprises a stretchable fabric coupled to the internal structural member that covers the internal structural member such that the stretchable fabric engages the virtual reality headset to press the headset against the face of the user when the headset holder is tightened.

In some embodiments, the tightener and the tightening strap comprise a ratchet mechanism that facilitates incremental tightening of the virtual reality headset against the face of the user, and prevention of the tightening strap from passing through the tightener in a direction opposite the tightening direction, unless released by the user via a release mechanism included in the tightener. In some embodiments, the headset holder may be configured to couple with a hole formed in a visor of the helmet. In some embodiments, the virtual reality headset comprises a flexible display screen.

Another aspect of the present disclosure relates to a virtual reality motion simulation system and corresponding method. The system comprises one or more hardware processors configured by machine readable instructions to: facilitate entry and/or selection of information indicating a virtual reality motion experience for presentation to a user via a virtual reality headset worn by the user, and control commands related to starting and/or stopping such a presentation, wherein the entry and/or selection of information is performed by an operator using an operator control system that is located remotely from the virtual reality headset; cause presentation of the selected virtual reality motion experience to the user via the virtual reality headset; receive information from sensor output signals indicating body position, head position, and/or eye position of the user during the virtual reality motion experience; and adjust the presentation of the virtual reality motion experience based on the control commands, and the body position, head position, and/or eye position of the user.

In some embodiments, the one or more hardware processors may be further configured to present the virtual reality motion experience to a plurality of users on a plurality of virtual reality headsets worn by the users, and individually control the virtual reality motion experience for specific ones of the users based on information in output signals from sensors associated with the specific ones of the users such that the virtual reality motion experience is coordinated across the plurality of virtual reality headsets worn by the plurality of users.

In some embodiments, the one or more hardware processors may be configured to facilitate selection of the virtual reality motion experience and selection of individual ones of the plurality of virtual reality headsets for presentation of the virtual reality motion experience using the operator control system, the virtual reality headset, and/or other components. The operator control system may be located remotely from the plurality of virtual reality headsets. In some embodiments, the one or more hardware processors may be configured to display the virtual reality motion experience for one or more of the plurality of users to the operator via the operator control system. In some embodiments, the one or more hardware processors may be configured to wirelessly communicate with the virtual reality headset via an open source Paho library, an Amazon Web Services Internet of Things (AWS-IOT) client, an open source messaging system, an internet messaging protocol, and/or other protocols, and/or by other methods. In some embodiments, the open source messaging system and/or the internet messaging protocol may comprise a message queuing telemetry transport (MQTT) broker, for example.

Yet another aspect of the present disclosure relates to a virtual reality motion simulation system (and corresponding method) comprising the virtual reality headset helmet adaptor, one or more sensors, the one or more hardware processors, and/or other components. As described above, the virtual reality headset helmet adaptor may be configured to couple with a helmet and removably retain a virtual reality headset against the face of a user such that virtual reality images displayed by the virtual reality headset remain viewable with eyes of the user when the user wears the helmet and the virtual reality headset. The virtual reality headset helmet adaptor may be configured to be operated by the user to tighten the virtual reality headset against the face of the user. The one or more sensors may be configured to generate output signals that convey information related to a body position, a head position, and/or an eye position of the user, and/or other information. The one or more hardware processors may be configured by machine readable instructions to: facilitate entry and/or selection of information indicating a virtual reality motion experience for presentation to the user via the virtual reality headset, and control commands related to starting and/or stopping such a presentation, wherein the entry and/or selection of information is performed by an operator using an operator control system that is located remotely from the virtual reality headset; cause presentation of the selected virtual reality motion experience to the user via the virtual reality headset; receive the information in the sensor output signals indicating body position, head position, and/or eye position of the user during the virtual reality motion experience; and adjust the presentation of the virtual reality motion experience based on the control commands, and the body position, head position, and/or eye position of the user.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 depicts a skydiving system, in accordance with one or more example embodiments.

FIG. 2 depicts a helmet apparatus, in accordance with one or more example embodiments.

FIG. 3 depicts a skydiving simulation process, in accordance with one or more example embodiments.

FIG. 4 is a schematic summary illustration of the present system, in accordance with one or more example embodiments.

FIG. 5 illustrates a first view of a virtual reality headset helmet adaptor, in accordance with one or more example embodiments.

FIG. 6 illustrates a second view of a virtual reality headset helmet adaptor, in accordance with one or more example embodiments.

FIG. 7A-7L illustrate several examples of a helmet, a virtual reality headset, a display, helmet mounting brackets, and/or other components of present system, in accordance with one or more example embodiments.

FIG. 8 illustrates processors communicating with virtual reality headsets via an internet messaging protocol comprising an MQTT broker (for example), in accordance with one or more example embodiments.

FIG. 9 illustrates a method for securing a virtual reality headset to a helmet, in accordance with one or more example embodiments.

FIG. 10 illustrates a virtual reality motion simulation method, in accordance with one or more example embodiments.

FIG. 11 illustrates another virtual reality motion simulation method, in accordance with one or more example embodiments.

### DETAILED DESCRIPTION

There are many sports and/or other activities enjoyed by large numbers of people worldwide. Participation in many of these sports and/or other activities requires both physical and mental fitness. Participants must contend with environmental factors, health limitations, safety risks, fear, and/or other factors to participate. For a variety of reasons, not every potential participant has the mental and/or physical capacity to overcome these difficulties. However, a virtual reality based system may be used to provide a realistic feeling experience of sports and/or other activities without having to overcome the environmental factors, health limitations, safety risks, fear, and/or other factors.

By way of a non-limiting example, skydiving is an adventure sport enjoyed by hundreds of thousands of people worldwide. Participation in the sport requires both physical and mental fitness. Skydivers must contend with reduced oxygen due to the high altitudes required for skydiving. Unfortunately, not everyone has the physical capacity to skydive for a variety of health related reasons and/or other reasons. However, a ground-based wind tunnel may be used to provide much of the experience of skydiving without having to ride an aircraft to altitude and jump out. Indoor skydiving may provide a useful and fun alternative to skydiving from aircraft.

Indoor skydiving utilizes powerful fans that produce airflow directed to oppose gravity. The fans direct the airflow through a chamber to an indoor skydiver that is the suspended in the chamber by the airflow. The airflow is of a velocity high enough to cause sufficient drag on the skydiver to suspend the skydiver against gravity in the chamber. The indoor skydiver may experience many of the same sensations as if the indoor skydiver was outdoors and actually skydiving.

A virtual reality motion experience (e.g., video and/or other content) presented to the indoor skydiver may enhance the indoor skydiver's experience. Video and/or other content may be presented to the indoor skydiver on a virtual reality display device (e.g., a headset) included in and/or coupled with the skydiver's helmet. Virtual reality may allow the indoor skydiver to look around images, a scene, and/or experience motion captured during an actual skydive presented on the virtual reality display device. The indoor skydiver may select to experience virtual reality images, scenes, and/or motion from a list of pre-recorded skydives. As described herein, in some embodiments, the helmet worn by the indoor skydiver may include an audio transceiver to allow an instructor to converse with the indoor skydiver. In some embodiments, the virtual reality images, scene, and/or motion may also be viewed by an instructor outside the indoor skydiving chamber.

Although many of the examples described herein are related to indoor skydiving, this is not intended to be limiting. The virtual reality helmet and/or other components of the system described herein may be used for simulating other physical activities, providing a virtual reality experience where a user would normally wear a helmet for a corresponding physical version of the experience. Some of these activities include skateboarding, bike riding, motorcycle riding, driving a racecar, hang gliding, parasailing, and/or other action and/or airborne sports, and/or other activities. In some embodiments, one or more components of the present system may be utilized to simulate activities where helmets are not normally worn. Such activities may include surfing (e.g., natural and/or artificial (man-made) waves), scuba diving, bull riding, and/or other activities. In some embodiments, the virtual reality headset helmet adaptor (described below), the operations performed by the one or more processors (described below), and/or other components of the present system may be used together as a single system, and/or may operate and/or be used separately from each other as stand-alone components.

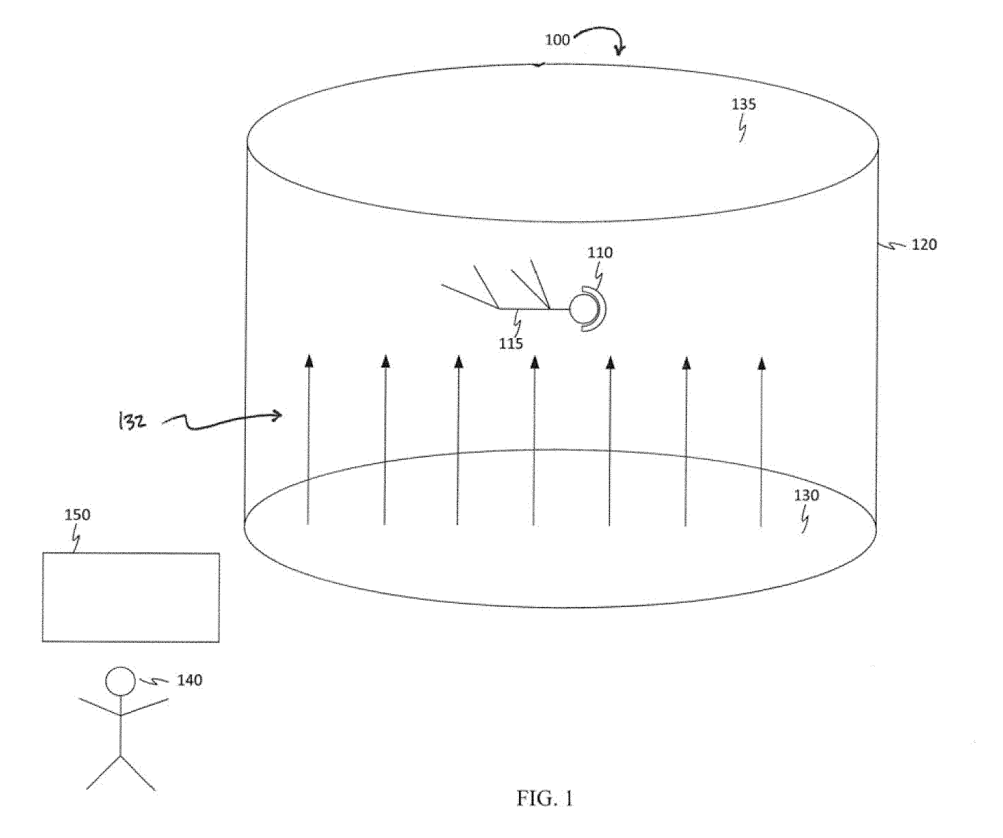

Continuing with the indoor skydiving example discussed above, FIG. 1 depicts an indoor skydiving arrangement 100 that includes components of the present system, in accordance with one or more example embodiments. Indoor skydiving arrangement 100 may include skydiving chamber 120 and/or other components. Fans generate airflow 132 passing from the bottom 130 of chamber 120 to the top 135 of chamber 120. Indoor skydiver 115 is positioned in airflow 132 so that gravity pulls skydiver 115 toward the bottom 130 of the chamber 120 and the airflow 132 hitting skydiver 115 causes drag that pushes against gravity to suspend skydiver 115 above bottom 130.

Skydiver 115 may wear helmet 110. Helmet 110 may provide the skydiver's head protection from impacts against the walls of chamber 120 as well as protection from impacts from other skydivers in chamber 120 (only one indoor skydiver shown in FIG. 1 but other skydivers may be in chamber 120 at the same time). Helmet 110 may also include a visor, a virtual reality headset (e.g., goggles), an audio transceiver to communicate with an operator (e.g., a skydiving instructor) 140 outside chamber 120, and/or other components. An operator control system/display 150 may duplicate for operator (e.g., the skydiving instructor) 140 the images, scene, and/or motion experience (e.g., video and/or other content) seen by skydiver 115 via the virtual reality headset.

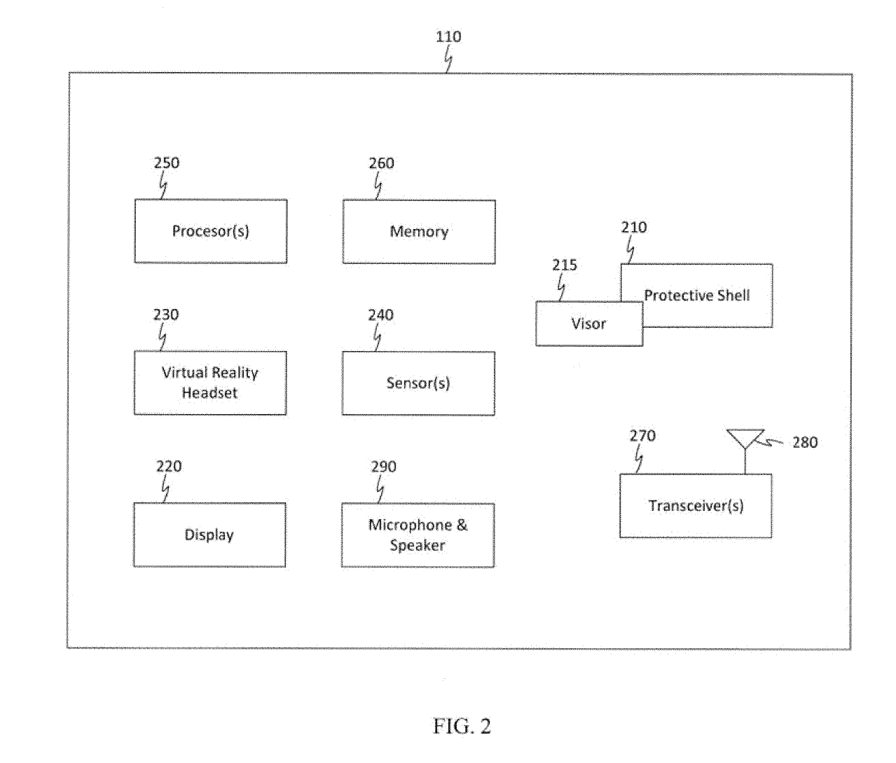

FIG. 2 depicts skydiving (this particular type of helmet is not intended to be limiting) helmet 110, in accordance with one or more example embodiments. Skydiving helmet 110 may include a protective shell 210, a visor 215, a display 220, a virtual reality headset 230, one or more sensors 240, a microphone and/or speaker 290, one or more processors 250, memory 260, one or more transceivers 270, one or more antennas 280, and/or other components.

FIG. 2 illustrates protective shell 210 as a component within helmet 110. This is not intended to be limiting. Protective shell may form an outer layer and/or other layers of helmet 110 for example. Protective shell 210 may include a rigid outer shell, a softer inner shell, and/or other components. For example, the outer shell may be produced from fiberglass, carbon fiber, Kevlar, other rigid materials, a combination of materials, and/or other materials. The softer inner shell may be produced from a Styrofoam, other foam material, any combination of impact absorbing materials, and/or other materials. Protective shell 210 may protect the head of skydiver 115 (FIG. 1) from impacts with the walls of indoor skydiving chamber 120 (for example), another skydiver, other movable and/or immovable objects, and/or other impacts. Protective shell 210 may be produced in the shape of a commercially available (e.g., skydiving) helmet, the shape of a full-face (e.g., motorcycle) helmet, the shape of an open face (e.g., motorcycle) helmet, and/or the shapes of other helmets. Protective shell 210 may include a visor configured to allow the wearer to see through the visor while wearing the helmet and protect the wearer form rushing air and/or small objects such as small rocks or other objects in the chamber 120 (FIG. 1), for example.

As described above, helmet 110 may include virtual reality headset 230 and/or other components. Virtual reality headset 230 may extend through visor 215 and protective shell 210 (as described below). For example, virtual reality headset 230 may extend through an opening in visor 215 and may be attached to visor 215 with an attachment mechanism (described below). The opening in the visor 215 that headset 230 extends into causes virtual reality headset 230 to be positioned in front of the wearer's (e.g., the skydiver and/or other users) eyes. Display 220 may be attached to and/or included in virtual reality headset 230 and configured to present the virtual reality images, scene, and/or motion experience (e.g., video and/or other content) to the helmet wearer.

In some example embodiments, helmet 110 may include one or more sensors 240 such as an eye-tracking sensor configured to generate output signals that convey information related to the position of one or both eyes of the wearer (e.g., the skydiver and/or other users) and/or other sensors. The position of the wearer's eyes may be used by one or more of the processors described herein to determine (e.g., as described below), at least in part, the images, scene, and/or motion experience presented to the indoor skydiver. For example, when the wearer's eyes look left, the eye-tracking device may provide information that is used to cause display 220 and/or virtual reality headset 230 to produce the virtual reality images, scene, and/or motion to the left in proportion to the wearer's eye movement. In some example embodiments, information in output signals from a head motion sensor 240 may be used to determine the appropriate images, scene, and/or motion to provide on display 220. For example, one or more accelerometers may form head motion sensor 240. Information in output signals from the one or more accelerometers may be used to determine that the helmet wearer has turned their head to the right and/or to determine other information. The accelerometer information may be used, at least in part, to determine the appropriate images, a scene, and/or motion to provide at display 220 to the helmet wearer. In this way, helmet 110 coupled with virtual reality headset 230 and display 220 may provide virtual reality images, scenes, and/or a motion experience to the helmet wearer. In some example embodiments, sensors 240 may include a switch and/or other devices configured to provide a confirmation to processor(s) 250 for a selection made by the wearer via display 220, virtual reality headset 230, and/or other components of the present system. In some example embodiments, sensors 240 may include a camera and/or other image capture devices. An image from the camera may be presented (passed through virtual reality headset 230) to the wearer in a portion of display 220 to aid the wearer in determining his/her position in the chamber (e.g., as shown in FIG. 1), and relative to any other skydivers in the chamber, and/or for other reasons (e.g., simply to view the physical world outside virtual reality headset 230). Processor(s) 250, processor(s) 410, and/or other processors may determine that the wearer is close to an object based on information from a proximity sensor 240 (for example) and cause display 220 to show or enlarge the image from the camera.

As described above, in some example embodiments, helmet 110 may include one or more proximity sensors 240 configured to generate output signals that convey information related to a proximity of the skydiver (e.g., and/or any other user) to nearby people and/or objects. The information in the output signals from proximity sensors 240 may be used by the processors described herein to aid the wearer in determining their position in chamber 120 (FIG. 1). For example, a proximity sensor 240 may generate output signals that include information used to determine a distance or proximity of helmet 110 to another object such as the chamber 120 (FIG. 1) wall, another skydiver, and/or other objects. The distance and/or proximity information may be provided to the wearer so that the wearer can adjust their movement and/or position to avoid impacting objects that could cause injury. An indication of the distance or proximity of nearby objects may be displayed on display 220 via virtual reality headset 230, and/or as a separate indication to the wearer, for example.

In some example embodiments, a flexible screen may be included in, coupled to, and/or replace the visor 215, virtual reality headset 230, and/or display 220. The flexible screen may include light emitting diodes, and/or a light emitting material configured to provide the virtual reality images, scene, and/or motion to the helmet wearer.

As described above, helmet 110 may include one or more processors 250, memory 260, and/or other components. In some embodiments, processors 250 may be and/or be included in processors 410 described below. In some embodiments, memory 260 may be and/or be included in electronic storage 412 described below. In some embodiments, one or more processors 250 and/or memory 260 may perform computing operations to generate the virtual reality images, scene, and/or motion presented on display 220 via virtual reality headset 230 to the virtual skydiver. Processors 250 and/or memory 260 may generate the virtual reality images, scene, and/or motion based on information from one or more sensors 240, virtual reality images, scenes, and/or motion experiences that may be stored in memory 260, commands received from an operator via display 150 (display 150 may be included in a larger operator control system as described below), and/or other information. For example, processor(s) 250 and/or memory 260 may include executable code that adjusts the images, scene, and/or motion on display 220 based on information from an eye-tracking sensor 240, one or more accelerometers 240, proximity sensor(s) 240, other information from other sensors 240, and/or other information. As a result and as described above, when an indoor skydiver (for example) turns their head left, accelerometer information may be processed by processor(s) 250 and/or memory 260 to cause the virtual reality images, scene, and/or motion to move left (as would naturally occur in an actual skydive). By way of a second non-limiting example, sensors 240 may include a heart rate and/or other physiological sensors configured to generate output signals conveying information related to a heart rate and/or other physiological characteristics of a user. Processor(s) 250 and/or memory 260 may include executable code that adjusts the images, scene, and/or motion on display 220 based on information from an eye-tracking sensor 240, one or more accelerometers 240, proximity sensor(s) 240, a heart rate sensor 240, and/or other information from other sensors 240, and/or other information. In this example, when the heart rate (and/or other physiological characteristics) of an indoor skydiver (for example) indicate the skydiver is overly nervous (e.g., the heart rate has breached a threshold level), processor(s) 250 and/or memory 260 may adjust the virtual reality images, scene, and/or motion to calm the skydiver (e.g., slow the experience down, etc.). These examples are not intended to be limiting.

Processor(s) 250 may process eye-tracking and/or other information to cause a change in the images, scene, and/or motion at display 220 in response to eye movement to produce the images, scene, and/or motion that would occur in an actual skydive due the eye movement. In some embodiments, responsive to proximity information indicating that a user is in a specific position relative to other users, a wall and/or other objects, and/or other positions, processor(s) 250 may cause a warning to be displayed on display 220 and/or take other actions to inform the user of his or her position. For example, the wearer may see a visual warning on display 220, or hear an audible warning from speaker 290 when helmet 110 gets within a predetermined distance from the wall of chamber 120 (FIG. 1). The predetermined distance may be up to about 3 feet, for example, and/or other distances (this example for this virtual skydiving embodiment is not intended to be limiting).

In some embodiments, virtual reality images, scenes, and/or motion experiences may be stored by memory 260, electronic storage 412 (described below), and/or by other components of the present system. Memory 260 and/or electronic storage 412 may store images, scenes, and/or motion experiences for any number of skydives (for example, this is not intended to be limited to only skydiving) in any number of different geographic locations.

In some embodiments, helmet 110 may include one or more transceivers 270 and/or other components. Transceiver(s) 270 may include radio transceiver(s), optical transceiver(s), wired transceiver(s), and/or other transceivers. For example, helmet 110 may include a radio transceiver 270 configured to transmit and/or receive radio signals to/from another transceiver at operator (e.g., skydiving instructor) 140 (e.g., via operator control system 150 described herein). The receiver in transceiver 270 may receive an analog and/or digital representation of an audio signal generated by a microphone at instructor 140 (FIG. 1), for example. The transmit portion of transceiver 270 may take an electrical signal generated by microphone 290 and/or digital representation of the generated signal and transmit the signal and/or digital representation to a receiver at instructor 140. A receiver at instructor 140 may regenerate the indoor skydiver's voice at instructor 140. In this way the indoor skydiver 115 (FIG. 1) and/or other types of users and instructor 140 may communicate. (Again, this example is not intended to be limiting and may apply to a user using the present system to participate in any virtual activity with a corresponding operator using an operator control system as described herein). Transceiver 270 may use antenna 280 and/or other components to transmit and receive signals corresponding to the audio communications between skydiver and instructor (for example).

In some embodiments, the images, scene, motion experience, and/or other information displayed at display 220 may be duplicated at operator control system/display 150 (FIG. 1) and/or other computing devices. In such embodiments, a transceiver 270 may transmit the video displayed at display 220 and/or other information to a receiver at instructor 140 for viewing at operator control system/display 150. In some embodiments, a transceiver 270 may transmit the video and/or other information displayed at display 220 to a receiver that is part of a display screen (and/or display screens) included external resources 414 (described below) for display. These display screens may be, for example, televisions and/or other display screens positioned so that spectators and/or other viewers may watch the virtual experience of the user (e.g., a skydiver in a wind tunnel). In some embodiments, such display screens may be configured to present virtual reality content such as images, scenes, motion experiences, branded focus screens for different wind tunnels, advertisements comprising video, images, text, and/or other information, etc. to the spectators. In some embodiments, the bidirectional audio communications between instructor and indoor skydiver may also be sent to the display screens and/or other devices included in external resources 414. In some embodiments, these display screens and/or other devices may subscribe to the signal transmitted from helmet(s) 110 via transceiver(s) 270, for example. In some embodiments, the bidirectional audio communications between instructor and indoor skydiver, and the images, scene, and/or motion experience sent from helmet 110 to operator control system/display 150 may use a single transceiver and/or multiple transceivers. In some example embodiments transceiver(s) 270 may operate in accordance with a cellular communications standard (e.g., 2G, 3G, 4G, 5G, GSM, etc.), any of the Wi-Fi family of standards, Bluetooth, WiMAX, and/or any other wireless, wired, or optical communications standard (e.g., external resources 414 described below). In some embodiments, the external video and/or other information playback described above may be facilitated by a standalone embedded system (e.g., Raspberry Pi 3) that is part of and/or associated with processors 410 (described below), external resources 414 (described below), operator control system 150, helmet 110, and/or other components of the present system and allows display screens and/or the operator control system/display 150 to “listen” to “Start” and “Stop” commands from processors 410 (described below) and/or other components of the present system via an internet messaging protocol (e.g., an MQTT client and/or other internet messaging protocols—also described below).

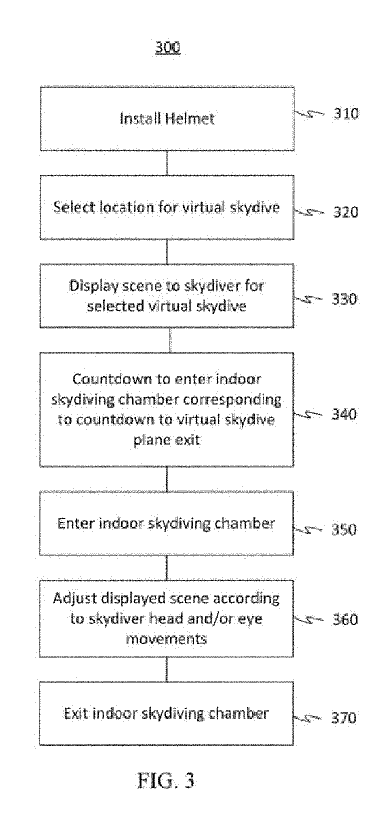

Continuing with the indoor skydiving example, FIG. 3 depicts a virtual skydiving simulation process 300, in accordance with one or more example embodiments. At an operation 310, an indoor skydiver straps on a helmet such as helmet 110 (FIGS. 1 and 2) described above. At an operation 320, the wearer and/or operator (e.g., the skydiving instructor) selects a location for the virtual skydive. For example, display 220 (FIG. 2) and/or operator control system/display 150 (FIG. 1) may present a list of sites for the virtual skydive. In some embodiments, the position of the wearer's eye may be tracked and determined to point at a particular selection on the display, for example. The wearer may be instructed to select a site by looking at a selection for the site on display 220 and/or selecting the site using the switch in sensor(s) 240 (FIG. 2). In some embodiments, a site may be selected by an operator via operator control system/display 150, and/or by other users using other computing devices. At an operation 330, the virtual reality headset 230 (FIG. 2) and display 220 may present the images, scene, and/or motion experience for the virtual skydive. At an operation 340 a countdown may be started. The countdown may correspond to the wearer's entry into the indoor skydiving chamber 120 (FIG. 1) and in the virtual skydive to exiting the airplane. At an operation 350, the wearer may enter the indoor skydiving chamber. At an operation 360, the images, scene, and/or motion experience may be adjusted by processor(s) 250 (FIG. 2), processors 410 (described below), and/or other components of the present system in response to information in output signals from an eye-tracking sensor, accelerometers, and/or other sensors 240 (FIG. 2) to cause adjustment of the images, scene, and/or motion experience on display 220 according to the wearer's movements as described above with respect to FIGS. 1 and 2. At an operation 370, the wearer may exit the indoor skydiving chamber.

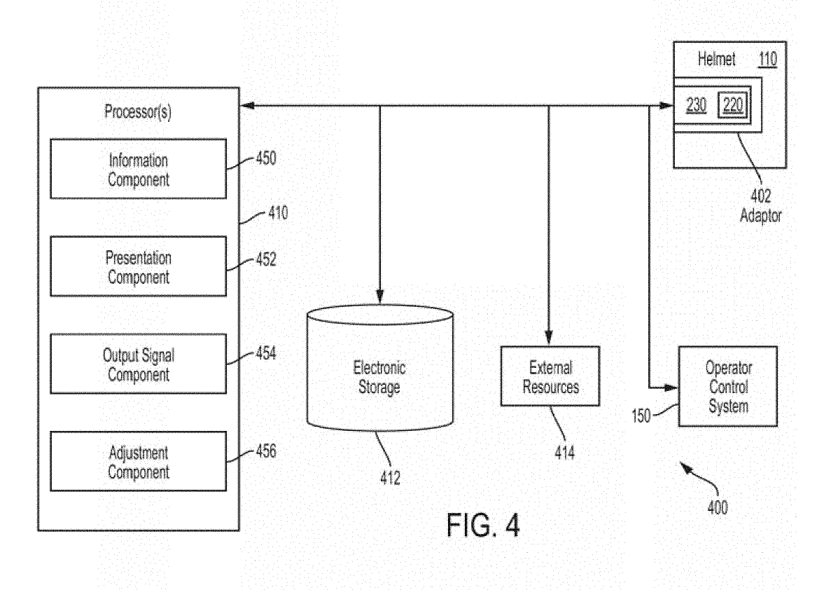

FIG. 4 is a schematic summary illustration of the present system 400. As shown in FIG. 4, system 400 includes helmet 110 with virtual reality helmet headset adaptor 402, virtual reality headset 230, and display 220; operator control system 150; one or more processors 410; electronic storage 412; external resources 414; and/or other components.

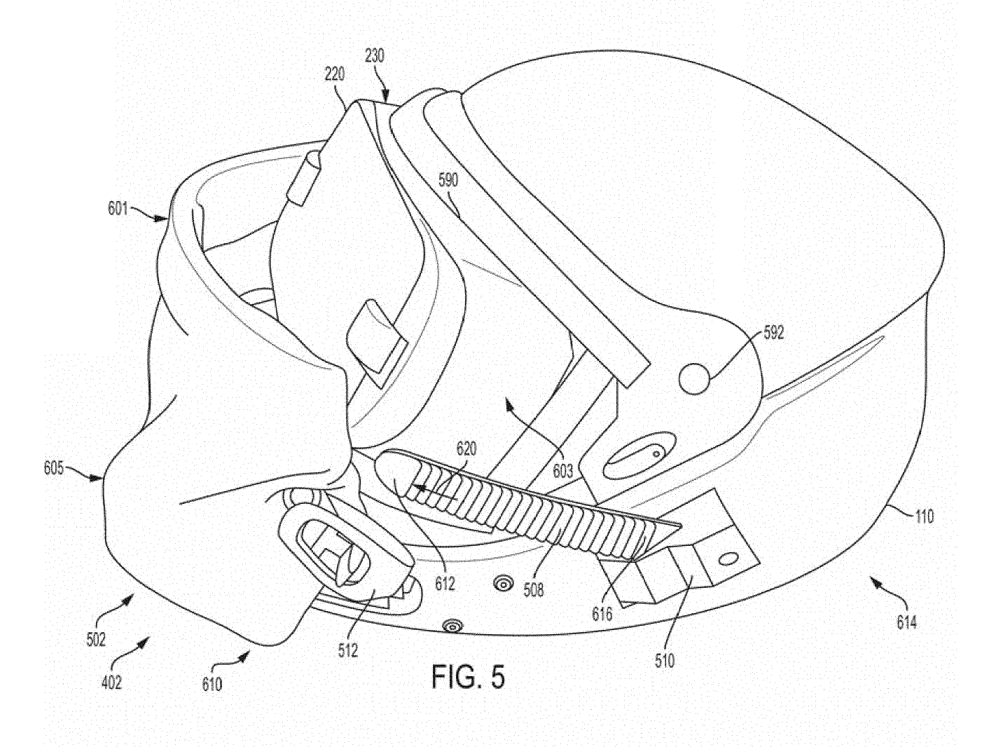

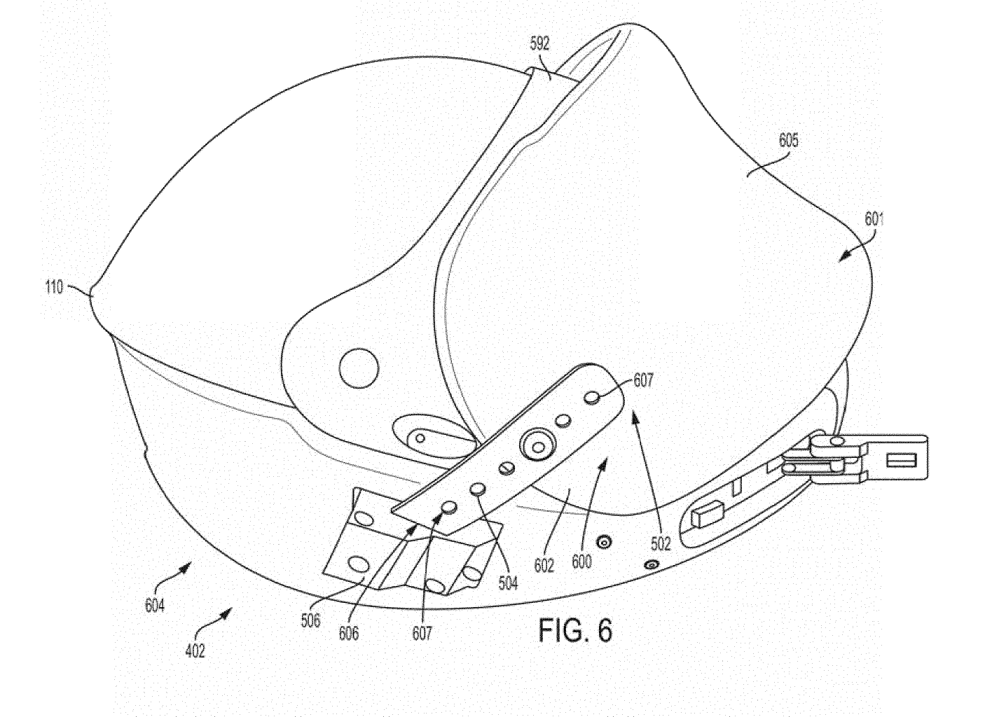

Virtual reality helmet headset adaptor 402 may be configured to facilitate removable coupling between helmet 110 and virtual reality headset 230 and/or display 220. Virtual reality helmet headset adaptor 402 is illustrated in FIG. 5 and FIG. 6. As shown in FIG. 5 and FIG. 6, adaptor 402 may include a headset holder 502, an anchor strap 504, an anchor bracket 506, a tightening strap 508, a tightening bracket 510, a tightener 512, and/or other components.

Headset holder 502 may be configured to couple with helmet 110 and removably retain virtual reality headset 230 (and/or display 220) against a face of a user such that virtual reality images displayed by virtual reality headset 230 and/or display 220 remain viewable by the user when the user wears helmet 110 and virtual reality headset 230. In some embodiments, headset holder 502 may be configured to couple with a hole 590 in a visor 592 of helmet 110. In some embodiments, headset holder 502 comprises an internal structural member 601 and/or other components. Internal structural member 601 may be and/or include a fracture-resistant frame and/or other components configured to surround an outer edge 603 of virtual reality headset 230 when headset holder 502 retains virtual reality headset 230 against the face of the user. Internal structural member 601 may support virtual reality headset 230 in alignment with eyes of the user, for example. In some embodiments, internal structural member 601 may be formed from one or more fracture resistant material including but not limited to acrylonitrile-butadiene-styrene (ABS), polypropylene, polyethylene, high-impact polystyrene, polyacetals and/or nylons, as well as non-thermoplastic polymers such as epoxies and polyurethanes, and/or other materials. In some embodiments, headset holder 502 may comprise a stretchable fabric 605 and/or other components coupled to internal structural member 601 that cover internal structural member 601 such that stretchable fabric 605 engages virtual reality headset 230 to press headset 230 against the face of the user when headset holder 502 is tightened (e.g., as described below).

Anchor strap 504 may be coupled to a first side 600 of headset holder 502 at or near a first end 602 of anchor strap 504. Anchor bracket 506 may be coupled to a corresponding first side 604 of helmet 110 and configured to receive and engage a second end 606 of anchor strap 504 to anchor headset holder 502 to helmet 110 via anchor strap 504. In some embodiments, anchor strap 504 may include holes 607 and/or other features configured to facilitate coupling of second end 606 and/or other portions of anchor strap 504 to first side 600 of headset holder 502. In some embodiments, anchor strap 504 may include a plurality of holes 607 running along a longitudinal axis of anchor strap 504 that facilitate coupling of anchor strap 504 to headset holder 502 at one or more different locations along anchor strap 504. In some embodiments, holes 607 may facilitate coupling of anchor strap 504 to headset holder 502 via coupling devices such as screws, nuts, bolts, clamps, clips, hook and eye fasteners, etc.

Tightening strap 508 may be configured to removably couple with a second side 610 of headset holder 502 at or near a first end 612 of tightening strap 508. Tightening bracket 510 may be coupled to a corresponding second side 614 of helmet 110 and configured to receive and engage a second end 616 of the tightening strap. Tightener 512 may be coupled to second side 610 of headset holder 502 and configured to be operated by the user to removably couple tightening strap 508 with second side 610 of headset holder 502. Tightener may removably couple tightening strap 508 with second side 610 of headset holder 502 by causing tightening strap 508 (e.g., starting with first end 612) to pass through tightener 512 in a tightening direction 620. In this way, headset holder 502 may engage virtual reality headset 230 and retain virtual reality headset 230 against the face of the user when the user wears helmet 110 and virtual reality headset 230.

In some embodiments, tightener 512 and tightening strap 508 may comprise a ratchet mechanism that facilitates incremental tightening of virtual reality headset 230 against the face of the user, and prevention of tightening strap 508 from passing through tightener 512 in a direction opposite tightening direction 620, unless released by the user via a release mechanism included in tightener 512. In some embodiments, tightening strap 508 may have a ridged and/or other surface that facilitates ratcheted incremental tightening. In some embodiments, end 612 may be and/or include a thinned tab to facilitate insertion into tightener 512 by the user. By way of a non-limiting example, in some embodiments, the ratchet mechanism formed by tightener 512 and tightening strap 508 may be similar to and/or the same as the ratchet mechanism used in snowboard bindings and/or other applications. Tightener 512 may be configured to tighten virtual reality headset 230 against the face of the user so that virtual reality headset 230 is held in place during the presentation of virtual reality content to the user (e.g., while the user is in the wind tunnel described above and/or participating in another simulated activity where virtual reality headset 230 may normally tend to move on the face of the user during the activity).

Returning to FIG. 4, virtual reality headset 230 and/or display 220 may be configured to present virtual reality content (images, scenes, motion experiences, branded focus screens for different wind tunnels, advertisements comprising video, images, text, and/or other information, etc.) to the user. In some embodiments, virtual reality headset 230 and/or display 220 may be and/or include a smartphone, a 360 degree video player, and/or other components configured to run software programs (e.g., communicated to and/or from processors 410 described below) and/or perform other operations. These devices may be configured to present the virtual reality content to the user such that the presented virtual reality content is immersive for the user and corresponds to a view direction of the user (e.g., as described above). In some embodiments, virtual reality headset 230 and/or display 220 may utilize the GearVR, Oculus, and/or other software development kits (SDK) in combination with a 360 degree video player and/or other components to facilitate a full immersive experience for a user. Virtual reality headset 230 and/or display 220 may be controlled by processor(s) 410, 250 (FIG. 2), operator control system 150, and/or other control devices to present the virtual reality content to the user such that the presented virtual reality content corresponds to a view direction of the user. In some embodiments, a user may use virtual reality headset 230 and/or display 220 to control presentation of the virtual images remotely (e.g., from inside a wind tunnel). Virtual reality headset 230 and/or display 220 may include one or more screens, projection devices, three dimensional image generation devices, light field imaging devices that project an image onto the back of a user's retina, virtual reality technology that utilizes contact lenses, virtual reality technology that communicates directly with (e.g., transmitting signals to and/or receiving signals from) the brain, and/or other devices configured to display the virtual reality content to the user. The one or more screens and/or other devices may be electronically and/or physically coupled, and/or may be separate from each other. As described above, in some embodiments, display 220 may be included in virtual reality headset 230 worn by the user. In some embodiments, display 220 may be a single screen and/or multiple screens included in virtual reality headset 230 and/or may be a standalone component. In some embodiments, virtual reality headset and/or display 220 may display camera pass through images (e.g., from a camera included in sensors 240) and/or other information so that a user may view his physical surroundings while still wearing a headset.

In some embodiments, virtual reality headset 230 may be configured to provide an interface between system 400 and users through which the users provide information to and receive information from system 400. Virtual reality headset 230 may enable cues, instructions, advertisements (e.g., branded focus screens for different wind tunnels), and/or any other communicable items, collectively referred to as “information,” to be communicated between a user and one or more components of system 400 (e.g., processors 410, operator control system 150, etc.). Examples of interface devices suitable for inclusion in virtual reality headset 230 comprise a keypad, buttons, switches, display 220 (e.g., which may form a touch screen), speakers and/or a microphone 290 (FIG. 2), an indicator light, an audible alarm, a tactile feedback device (e.g., for sensing vibrations during simulated movement), and/or other interface devices. Such interface devices may be used, for example, to control (e.g., start, stop, pause, communicate with an operator, etc.) a virtual reality experience remotely (e.g., by a user from inside a wind tunnel).

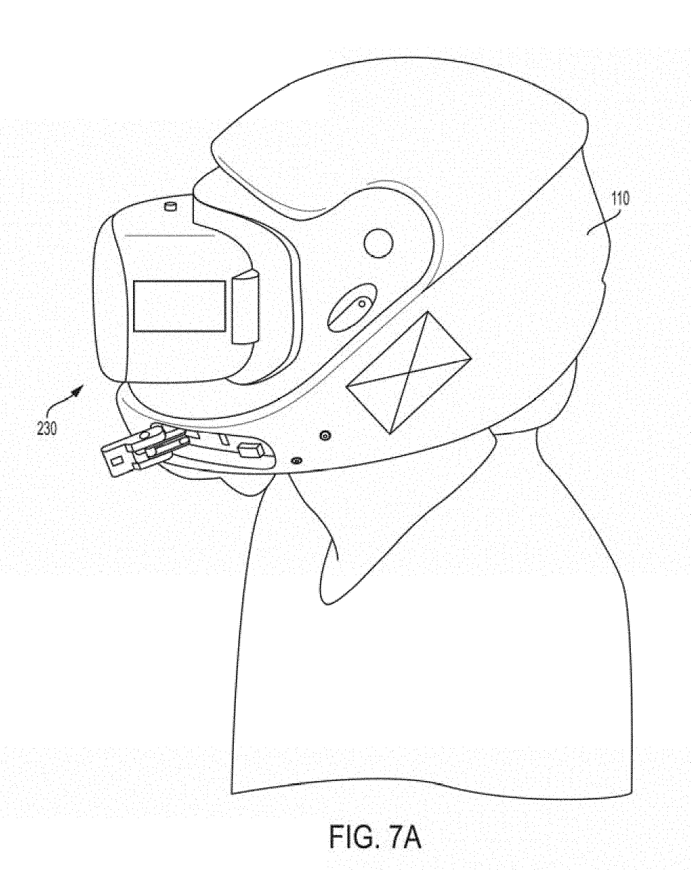

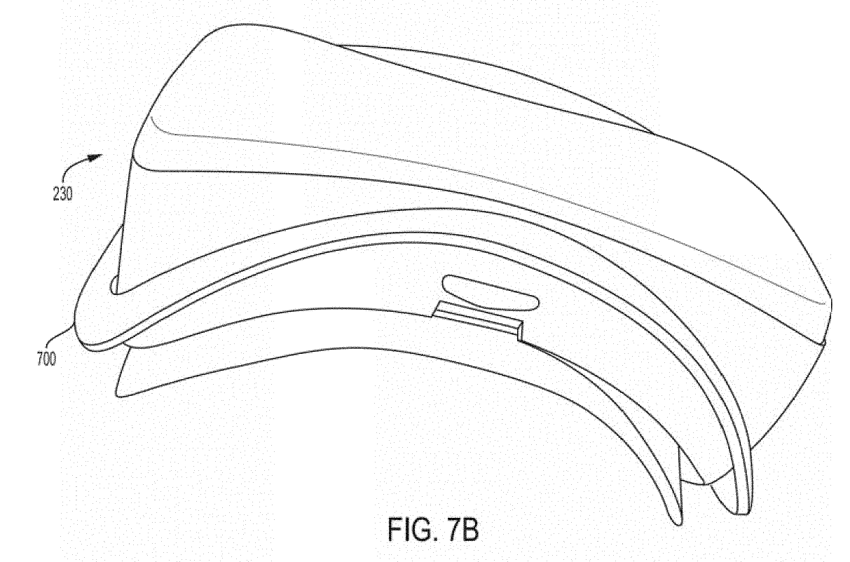

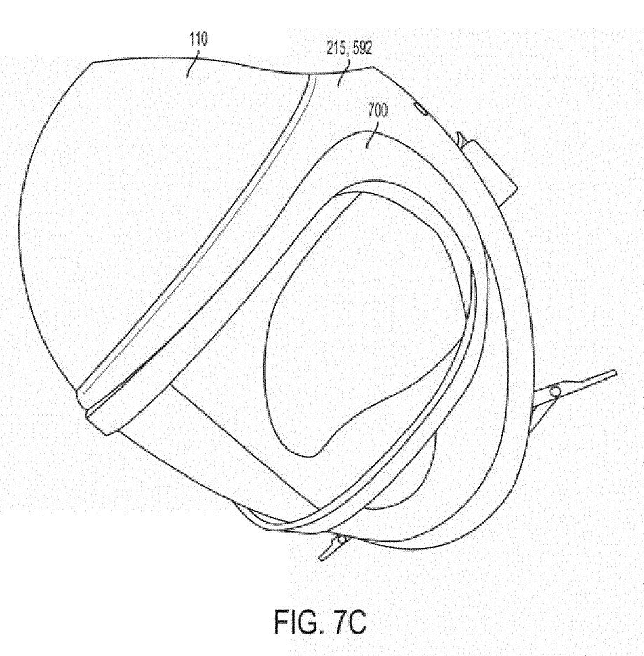

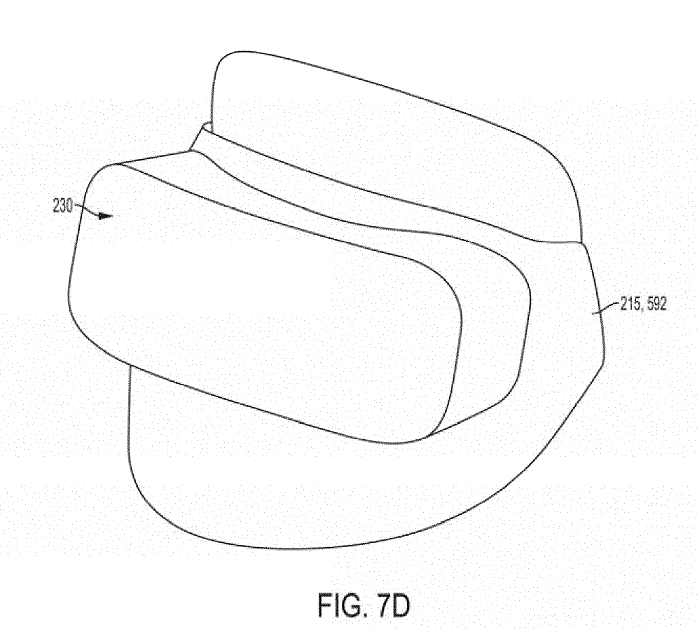

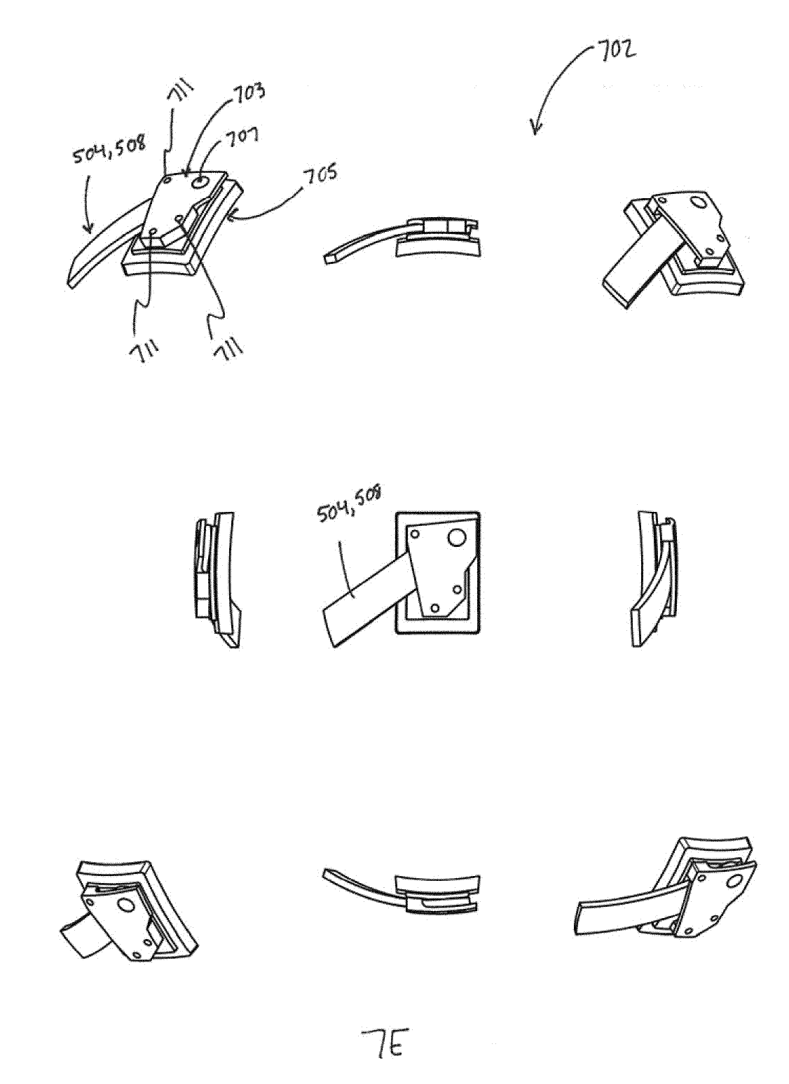

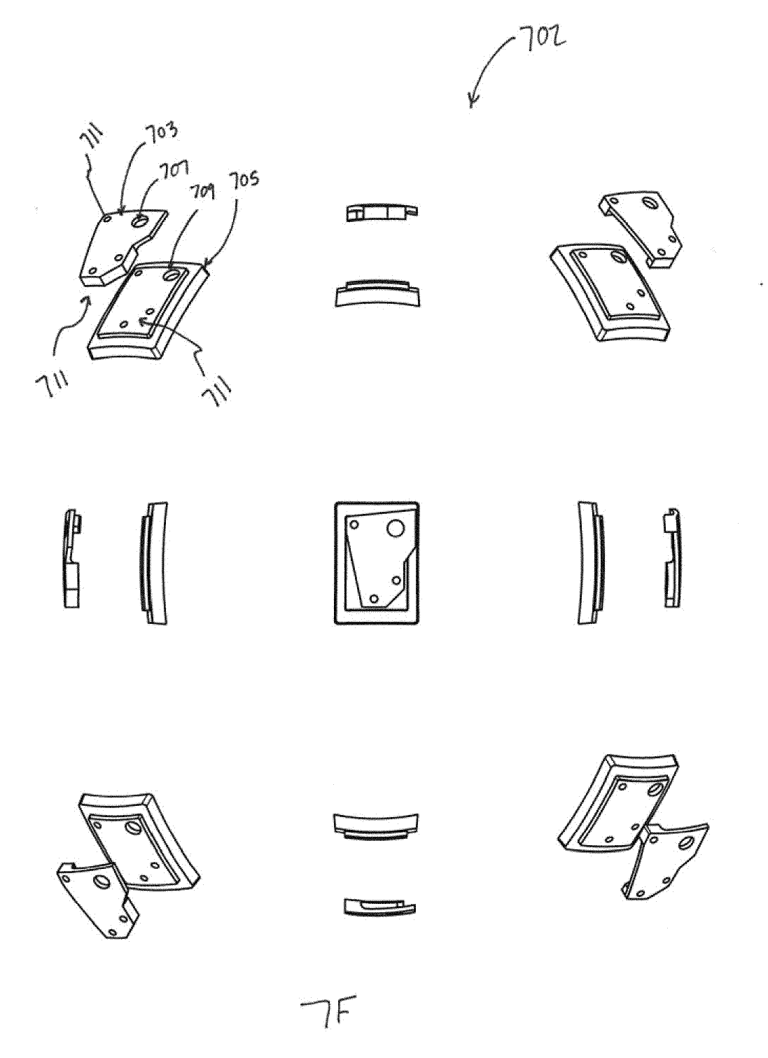

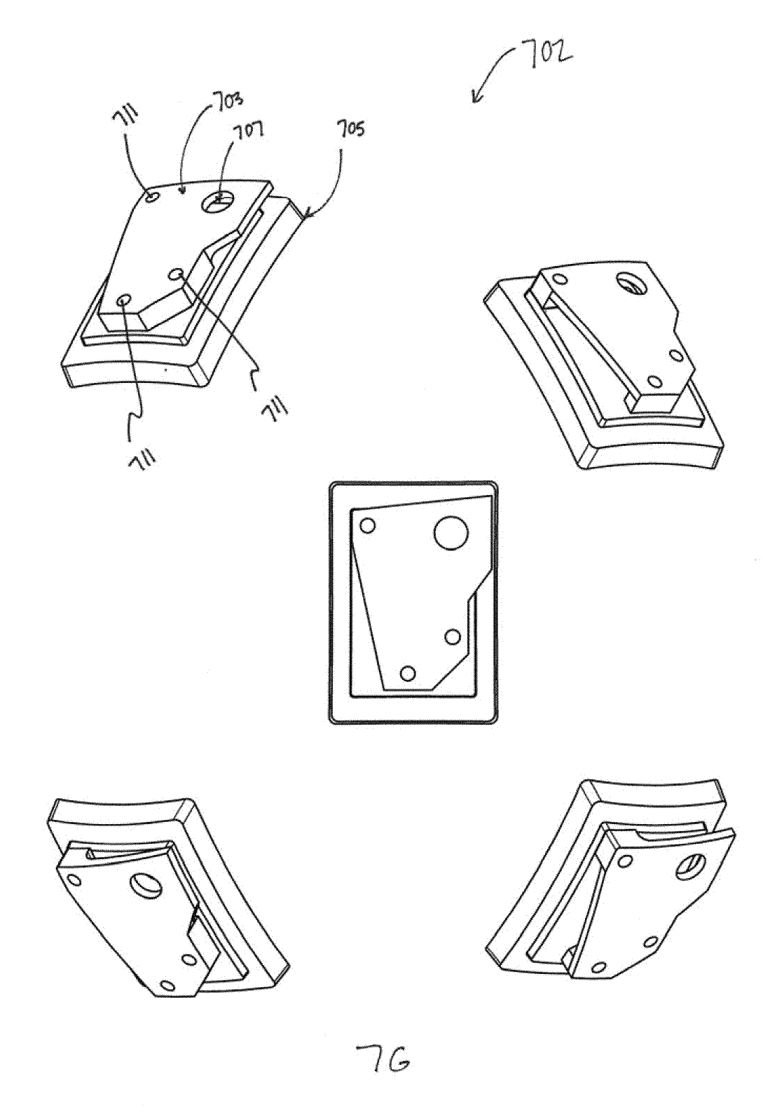

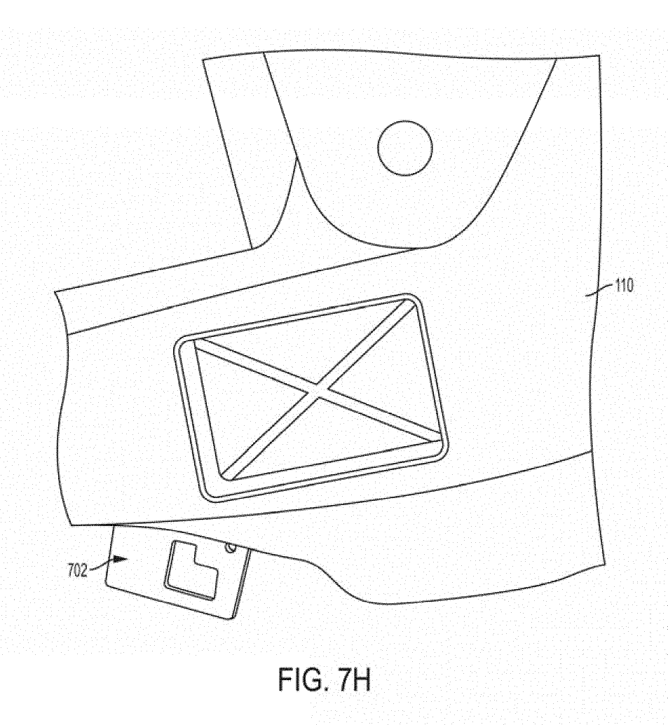

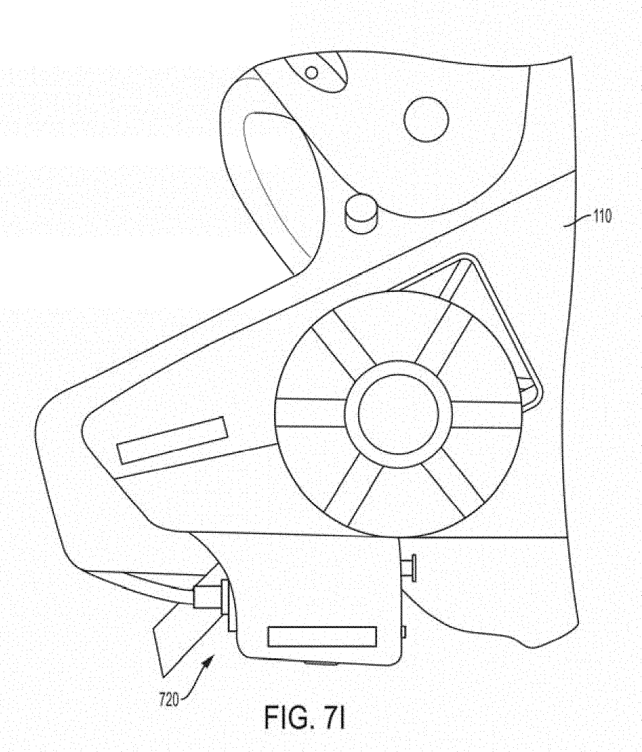

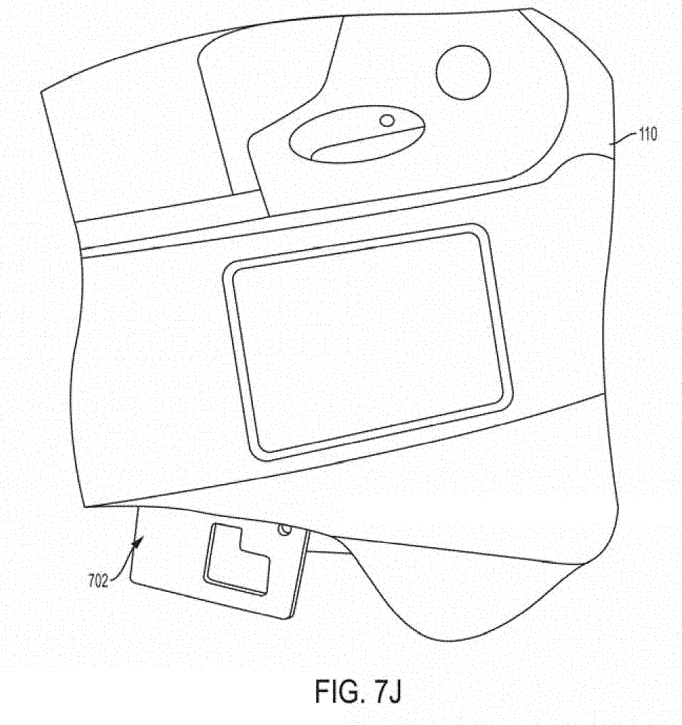

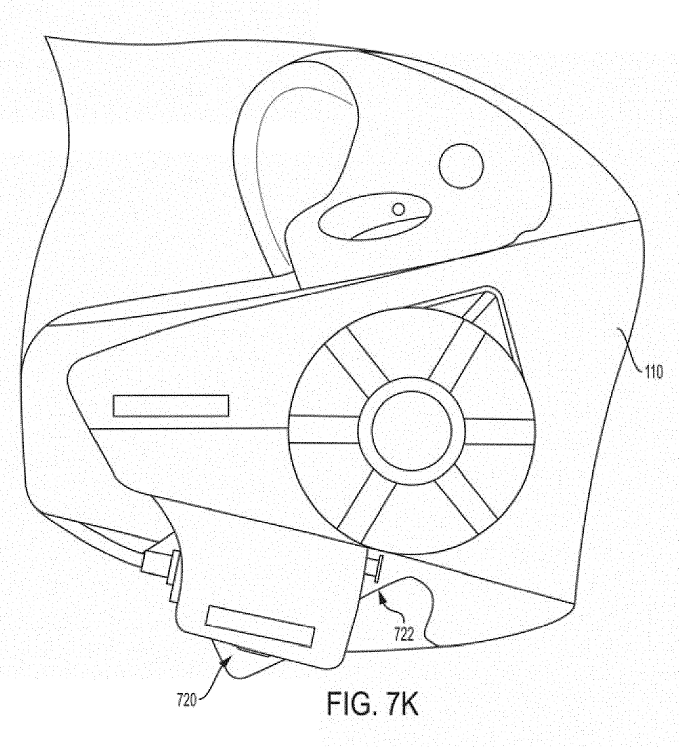

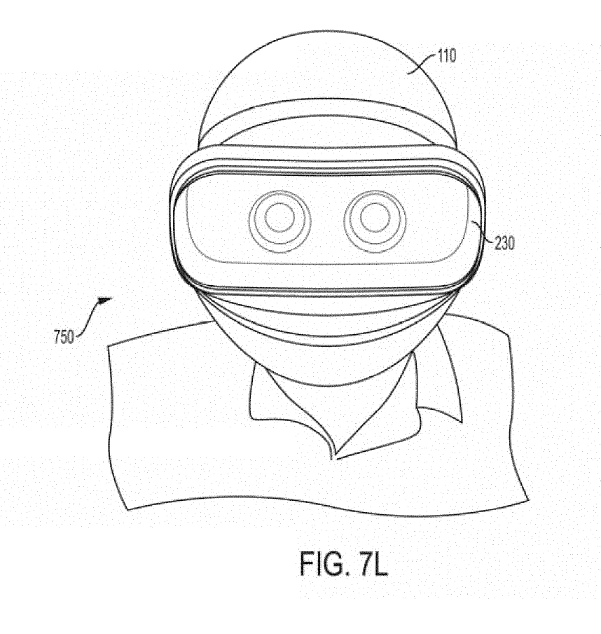

FIG. 7A-7L illustrate several examples of helmet 110, virtual reality headset 230, display 220, brackets 506 and 510, and/or other components of present system 400. For example, FIG. 7A illustrates an example helmet 110 and virtual reality headset 230. FIG. 7B illustrates virtual reality headset 230 and a mounting gasket 700 that may be optionally included in adaptor 402 (described above). FIG. 7C illustrates helmet 110, gasket 700, and visor 215, 592. In some embodiments, visor 215, 592 may be transparent, formed from high impact-strength, and/or have other properties. For example, visor 215, 592 may be formed from polycarbonate and/or other materials. FIG. 7D illustrates an example visor 215, 592 integrated with a virtual reality headset 230.

FIG. 7E-7G illustrate views of an example bracket assembly 702 configured to facilitate coupling with helmet 110 (FIG. 4). In some embodiments, bracket assembly 702 may form a portion of anchor bracket 506 (FIG. 5-6) and/or tightening bracket 510 (FIG. 5-6). The bracket assembly 702 provides a means of securing headset holder 502 (FIG. 5, FIG. 6) to helmet 110. The bracket assemblies 702 may be coupled in a number of ways to helmet 110. For example, they may be coupled via adhesives, mechanical fasteners, holes in the helmet, and/or other coupling techniques. In some embodiments, system 400 is configured such that a bracket assembly 702 for anchor bracket 506 (FIG. 5-6) and a bracket assembly 702 for tightening bracket 510 (FIG. 5-6) may be mirror images of each other. Bracket assembly 702 includes two pieces 703, 705, held together with mechanical fasteners (e.g., screw, nuts, bolts, etc.). Secured between the two pieces 703, 705 may be a component that interfaces with headset holder 502. For example, anchor bracket 506 may be coupled to headset holder via anchor strap 504 and/or other components. Anchor strap 504 may be made of a flexible, but not substantially stretchable material and function as described herein, for example. Tightening bracket 510 may be configured to couple with headset holder 502 via tightening strap 508 that is configured to interface with tightener 512 as described herein (e.g., in the embodiment shown herein as a mechanical ratchet mechanism, which is coupled to headset holder 502).

Hole 707 in the bracket assembly top piece 703 and the depression 709 in bracket assembly 702 base 705 act together to secure strap 504, 508 (e.g., either tightening strap 508 or anchor strap 504) to bracket assembly 702. This also has the effect of allowing rotation of the strap 504, 508 with respect to bracket assembly 702. The smaller holes 711 in bracket assembly 702 may be configured for hardware (e.g., nuts and bolts) to secure the two pieces 703, 705 of bracket assembly 702 together.

FIG. 7H is a view of bracket assembly 702 coupled with helmet 110. FIG. 71 illustrates a transceiver 720 coupled to helmet 110. FIG. 7J is another view of a bracket assembly 702 coupled to helmet 110. FIG. 7K is an illustration of transceiver 720 with a transmit switch 722 coupled to helmet 110. FIG. 7L is a front view 750 of virtual reality headset 230 and helmet 110.

Returning to FIG. 4, operator control system/display 150 may be a computing system configured to control the virtual reality motion experience (e.g., via processors 410 described below) and/or other content presented to the user. In some embodiments, operator control system 150 may be configured to control equipment and/or systems that are operating in conjunction with the present system. Continuing with the indoor skydiving example described herein, operator control system 150 may be configured to control the fan speed and/or other components of the indoor skydiving system in conjunction with the content presented to the user via virtual reality headset 230. Operator control system 150 may be configured to communicate with processor(s) 410, virtual reality headset(s) 230, electronic storage 412; external resources 414, and/or other components. In some embodiments, operator control system 150 includes one or more processors, memory, a display, and/or other components for controlling information presented by headsets 230, communicating information to and/or receiving information from an operator, and/or for other purposes. In some embodiments, operator control system 150 may be and/or include a desktop computer, a laptop computer, a tablet computer, a smartphone, a video game console, and/or other computing systems.

In some embodiments, operator control system 150 may include one or more user interfaces configured to provide an interface between the present system and an operator, and/or other users through which the operator and/or other users may provide information to and receive information from system 400. Like virtual reality headset 230, this enables data, cues, results, and/or instructions and any other communicable “information” to be communicated between the operator and one or more components of system 400. Examples of interface devices suitable for inclusion in operator control system 150 comprise a keypad, buttons, switches, a keyboard, knobs, levers, a display screen, a touch screen, speakers, a microphone, an indicator light, an audible alarm, a printer, a tactile feedback device, and/or other interface devices. In some embodiments, operator control system 150 may comprise a plurality of separate interfaces. It is to be understood that other communication techniques, either hard-wired or wireless, are also contemplated by the present disclosure as a user interface of operator control system 150. For example, the present disclosure contemplates that operator control system 150 includes a removable storage interface. In this example, information may be loaded into system 400 from removable storage (e.g., a smart card, a flash drive, a removable disk, etc.) that enables the operator(s) to customize the implementation of system 400. Other exemplary input devices and techniques adapted for use with operator control system 150 comprise, but are not limited to, an RS-232 port, RF link, an IR link, modem (telephone, cable or other), and/or other components.

Processor(s) 410 may be configured to provide information processing capabilities in system 400. As such, processors 410 may comprise one or more of a digital processor, an analog processor, a digital circuit designed to process information, an analog circuit designed to process information, a state machine, and/or other mechanisms for electronically processing information. Although processors 410 are shown in FIG. 4 as a single entity, this is for illustrative purposes only. In some embodiments, processors 410 may comprise a plurality of processing units. These processing units may be physically located within the same device (e.g., a laptop, desktop, tablet, and/or other computer; a server; processor 250 in helmet 110 shown in FIG. 2; operator control system 150, etc.), or processors 410 may represent processing functionality of a plurality of devices operating in coordination (e.g., processors 410 and processor 250, where processor 250 may be and/or be part of processors 410). In some embodiments, processors 410 may be remotely located (e.g., within a remote server) relative to virtual reality headset 230, operator control system 150, and/or other components of system 400.

For example, processors 410 may be and/or be included in a server and/or other computing devices configured to run a distributed web application and communicate with virtual reality headset 230 (a single virtual reality headset 230 is used as an example herein but this is not intended to be limiting, processors 410 may control and/or communicate with a plurality of headsets 230), operator control system 150, and/or other components of system 400. Processors 410 may communicate with and/or facilitate communication between such components via a network to manage, synchronize, and/or orchestrate virtual reality content presented to (e.g., played, paused, stopped, etc.) individual virtual reality headsets 230. Processors 410 may facilitate control (e.g., via operator control system 15) by operators of a plurality of virtual reality headsets 230 and/or other devices. In some embodiments, processors 410 may facilitate operator login (e.g., via operator control system 150) to system 400, entry and/or selection of available virtual reality 360 files, entry and/or selection of individual virtual reality headsets 230 for presentation of virtual reality motion experiences and/or other virtual content, and/or other operations. In some embodiments, processors 410 may cause playback of the virtual reality motion experience and/or other virtual content in a web application browser and/or other applications on operator control system 150 and/or other components of system 400.

In embodiments where processors 410 are and/or are included in a server, the server may include electronic storage (e.g., electronic storage 412 described below), communication components, and/or other components. The server may include communication lines, or ports to enable the exchange of information with a network and/or other computing platforms (e.g., virtual reality headsets 230). The server may include a plurality of hardware, software, and/or firmware components operating together to provide the functionality attributed herein to processors 410. For example, the server may be implemented by a cloud of computing platforms operating together as a server. The server, virtual reality headset 230, operator control system 150, electronic storage 412, external resources 414, and/or other components of system 400 may be operatively linked via one or more electronic communication links. For example, such electronic communication links may be established, at least in part, via a network such as the Internet, a local Wi-Fi network and/or any of the Wi-Fi family of standards, Bluetooth, cellular communications (e.g., 2G, 3G, 4G, 5G, GSM, etc.), WiMAX, and/or any other wireless, wired, or optical communications standard, and/or other networks. It will be appreciated that this is not intended to be limiting, and that the scope of this disclosure includes embodiments in which a server (processors 410), virtual reality headset 230, operator control system 150, electronic storage 412, external resources 414, and/or other components of system 400 may be operatively linked via some other communication media.

As shown in FIG. 4, processors 410 are configured to execute one or more computer program components. The one or more computer program components may comprise one or more of an information component 450, a presentation component 452, an output signal component 454, an adjustment component 456, and/or other components. Processors 410 may be configured to execute components 450, 452, 454, and/or 456 by software; hardware; firmware; some combination of software, hardware, and/or firmware; and/or other mechanisms for configuring processing capabilities on processors 410. In some embodiments, processors 410 may execute one or more of the operations described below and/or other operations substantially continuously (e.g., in real-time and/or near real-time), at predetermined intervals, responsive to occurrence of a predetermined event, and/or at other times. In some embodiments, the predetermined intervals, events, and/or other information may be determined at manufacture, based on user input via virtual reality headsets 230 and/or operator control system 150, and/or based on other information.

It should be appreciated that although components 450, 452, 454, and 456 are illustrated in FIG. 4 as being co-located within a single processing unit, in embodiments in which processors 410 comprise multiple processing units, one or more of components 450, 452, 454, and/or 456 may be located remotely from the other components (e.g., in processor(s) 250). The description of the functionality provided by the different components 450, 452, 454, and/or 456 described below is for illustrative purposes, and is not intended to be limiting, as any of components 450, 452, 454, and/or 456 may provide more or less functionality than is described. For example, one or more of components 450, 452, 454, and/or 456 may be eliminated, and some or all of its functionality may be provided by other components 450, 452, 454, and/or 456. As another example, processors 410 may be configured to execute one or more additional components that may perform some or all of the functionality attributed below to one of components 450, 452, 454, and/or 456.

Information component 450 may be configured to facilitate entry and/or selection of information indicating a virtual reality motion experience and/or other virtual reality content for presentation to a user via virtual reality headset 230 worn by the user. Information component 450 may be configured to facilitate entry and/or selection of control commands related to starting and/or stopping such a presentation. In some embodiments, information component 450 may be configured to facilitate selection of a virtual reality motion experience and selection of individual ones of a plurality of virtual reality headsets 230 for presentation of the virtual reality motion experience. In some embodiments, (as described herein) the entry and/or selection of control command and/or motion experience information may be performed by an operator using operator control system 150 and/or other entry and/or selection devices. In some embodiments, operator control system 150 may be located remotely from virtual reality headset 230 (as described above). In some embodiments, (as described herein) the entry and/or selection of control command and/or motion experience information may be performed by a user using headset 230 and/or other entry and/or selection devices.

For example, information component 450 may facilitate communication of commands such as “start”, “stop”, “update”, and/or other commands back and forth between processors 410, operator control system 150, virtual reality headset 230 and/or other components of system 400. Information component 450 may facilitate receipt of events and/or other information emitted back from headset 230. These events may include “online”, “command acknowledged”, “command completed”, and/or other events. In some embodiments, information component 450 facilitates starting a virtual reality motion experience and/or other content by publishing an event to a topic “start/<device id>” wherein a video identification is included as is a unique identification associated with the command. A virtual reality headset 230 then emits an event to topic “acknowledge/<command id>”, for example. Once presentation of virtual reality content (e.g., as described herein) finishes, the virtual reality headset 230 may emit an event to topic “complete/<command id>”.

In some embodiments, information component 450 facilitates stopping a virtual reality motion experience and/or other content by publishing an event to a topic “<device id>/stop/<video id>” wherein a video identification is included as is a unique identification associated with the command. A virtual reality headset 230 then emits an event to topic “acknowledge/<command id>”, for example. Once presentation of virtual reality content (e.g., as described herein) is stopped, the virtual reality headset 230 may emit an event to topic “complete/<command id>”.

In some embodiments, information component may facilitate manual software updates for software running on headsets 230 and/or other devices. In some embodiments, information component 450 may automatically push software and/or other updates to headsets 230 and/or other devices. In such embodiments, information component 450 may publish an event to topic “update/<device id>” wherein a manifest of videos (e.g., motion experiences) and corresponding unique identifications for the command are included. The virtual reality headset 230 may then emit an event to topic “acknowledge/<command id>”. Then virtual reality headset 230 may go through the manifest and gather the appropriate videos. Then, once virtual reality headset 230 finishes downloading the videos virtual reality headset 230 may emit an event to topic “complete/<command id>”.

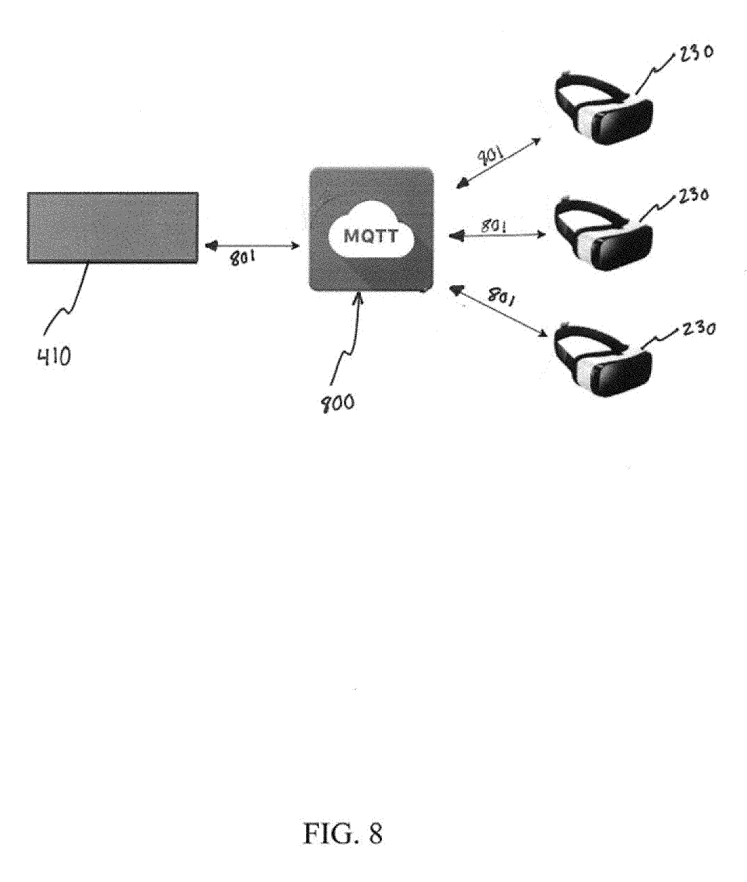

In some embodiments, information component 450 and/or other components of processor(s) 410 may be configured to wirelessly communicate with virtual reality headset 230, operator control system 150, display screens and/or other external resources 414, and or other devices via an open source Paho library, an Amazon Web Services Internet of Things (AWS-IOT) client, an open source messaging system, an internet messaging protocol, and/or other protocols. In some embodiments, components communicate via an internet messaging protocol and/or other protocols. In some embodiments, the open source messaging system and/or the internet messaging protocol comprises a message queuing telemetry transport (MQTT) broker, for example. This is an example only and not intended to be limiting. Those of ordinary skill in the art will recognize other communication methods and/or protocols. Such methods and/or protocols are contemplated here. By way of illustration, FIG. 8 illustrates processor(s) 410 communicating 801 with virtual reality headsets 230 via an MQTT broker 800 (again, as an example only). In some embodiments, information component 450 (FIG. 4) utilizes the open source Paho library, an AWS-IOT client and/or other resources in order to connect to the MQTT broker and/or other internet messaging protocols. Information component 450 and/or other components of processors 410 (FIG. 4) may be configured to receive commands, emit events (e.g., start, stop, update, etc.), and/or perform other functions using these and/or other communication protocols.

Returning to FIG. 4, presentation component 452 may be configured to cause presentation of a selected virtual reality motion experience to a user via virtual reality headset 230. In some embodiments, presentation component 452 may be configured to cause presentation of the virtual reality motion experience to a plurality of users on a plurality of virtual reality headsets 230 worn by the users, and individually control the virtual reality motion experience for specific ones of the users based on information in output signals from sensors (e.g., sensors 240 shown in FIG. 2) associated with the specific ones of the users such that the virtual reality motion experience is coordinated across the plurality of virtual reality headsets 230 worn by the plurality of users. In some embodiments, presentation component 452 may be configured to display the virtual reality motion experience for one or more of the plurality of users to the operator via operator control system 150.

Output signal component 454 may receive information from sensor output signals (e.g., from sensors 240 described above) indicating body position, head position, eye position, biometric feedback and/or other information from heart rate and/or other physiological sensors (e.g., included in sensors 240) and/or other information related to the user during the virtual reality motion experience. Adjustment component 456 may be configured to adjust the presentation of the virtual reality motion experience based on the control commands; the body position, head position, and/or eye position of the user; and/or other information. Adjustment component 456 may be configured to adjust the presentation of the virtual reality motion experience such that the presented virtual reality content is immersive for the user and corresponds to a view direction of the user (e.g., as described above).

Electronic storage 412 (and/or memory 260 described above) may comprise electronic storage media that electronically stores information. The electronic storage media of electronic storage 412 may comprise one or both of system storage that is provided integrally (i.e., substantially non-removable) with system 400 (e.g., within the same computing device and/or server that includes processor(s) 410) and/or removable storage that is removably connectable to system 400 via, for example, a port (e.g., a USB port, a firewire port, etc.) or a drive (e.g., a disk drive, etc.). Electronic storage 412 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 412 may store software algorithms, information determined by processors 412, information received via virtual reality headset 230 and/or operator control system 150, information related to selectable virtual reality motion simulation experiences, and/or other information that enables system 400 to function as described herein. Electronic storage 412 may be (in whole or in part) a separate component within system 400, or electronic storage 412 may be provided (in whole or in part) integrally with one or more other components of system 400 (e.g., together in a server and/or other computing device with processors 410, coupled with helmet 110 and/or virtual reality headset 230 (e.g., memory 260 may be and/or be included in electronic storage 412) etc.).

In some embodiments, electronic storage 412 may be caused by processor(s) 410 and/or other processors to log activity information for the present system. For example, electronic storage 412 may log which headsets were used for which virtual experiences, how many headsets were used (e.g., at a time, during a given day, etc.), how many times a specific virtual experience was selected, where the virtual experiences was displayed (e.g., display 220, operator control system 150, by display screens that are part of external resources 414), information displayed to and/or preferences of specific users, the name and/or identity of an operator, the names and/or identities of users, and/or other information.

External resources 414 may include sources of information that are outside of system 400, external entities participating with system 400, and/or other resources. In some embodiments, external resources 414 may include display screens (e.g., televisions) and or other equipment that facilitate display of the same and/or similar information (e.g., video, images) displayed to a user (e.g., a skydiver in a wind tunnel), and/or other information. In some embodiments, such display screens may subscribe to the signal transmitted from helmet(s) 110 via transceiver(s) 270 (shown in FIG. 2 and described above), for example. In some embodiments, external resources may include sources of biometric feedback and/or other information from heart rate and/or other physiological sensors. For example, external resources 410 may include fitness trackers and/or other wearable devices that generate output signals conveying heart rate and/or other physiological information. In some embodiments, some or all of the functionality attributed herein to external resources 414 may be provided by resources included in system 400.

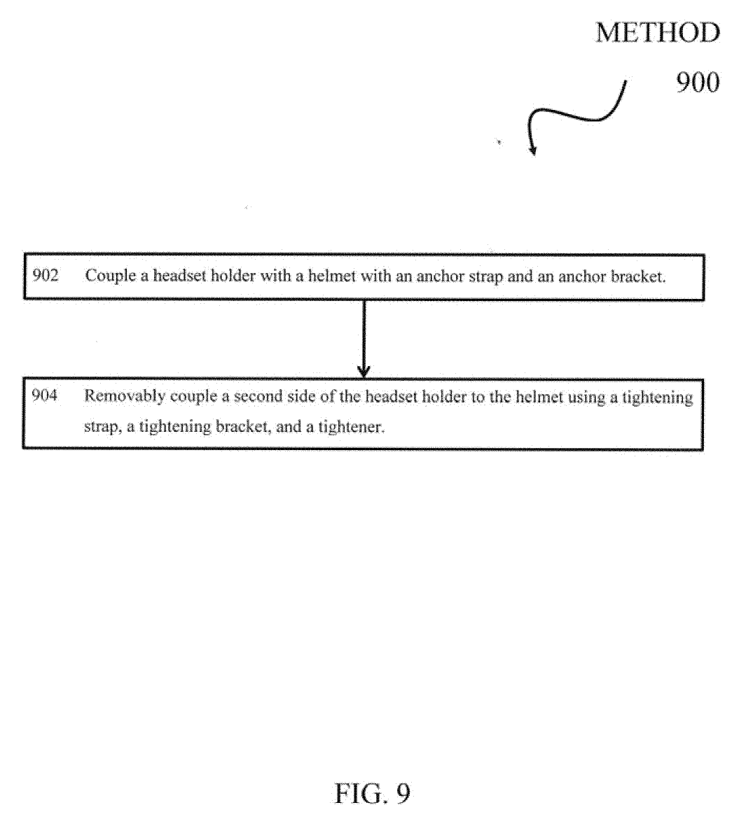

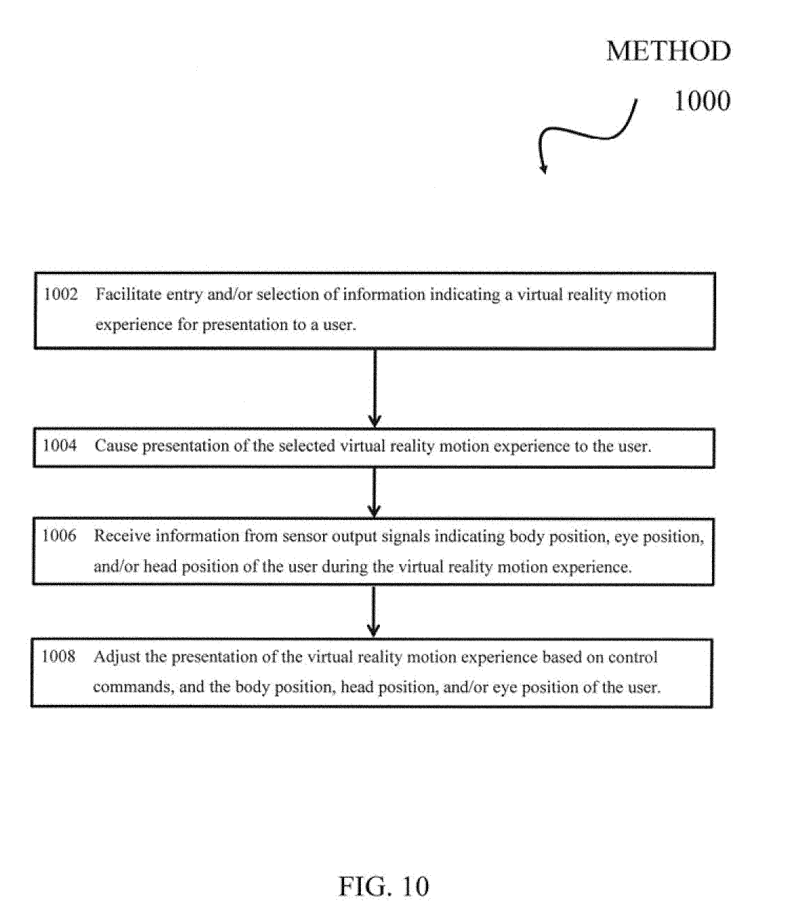

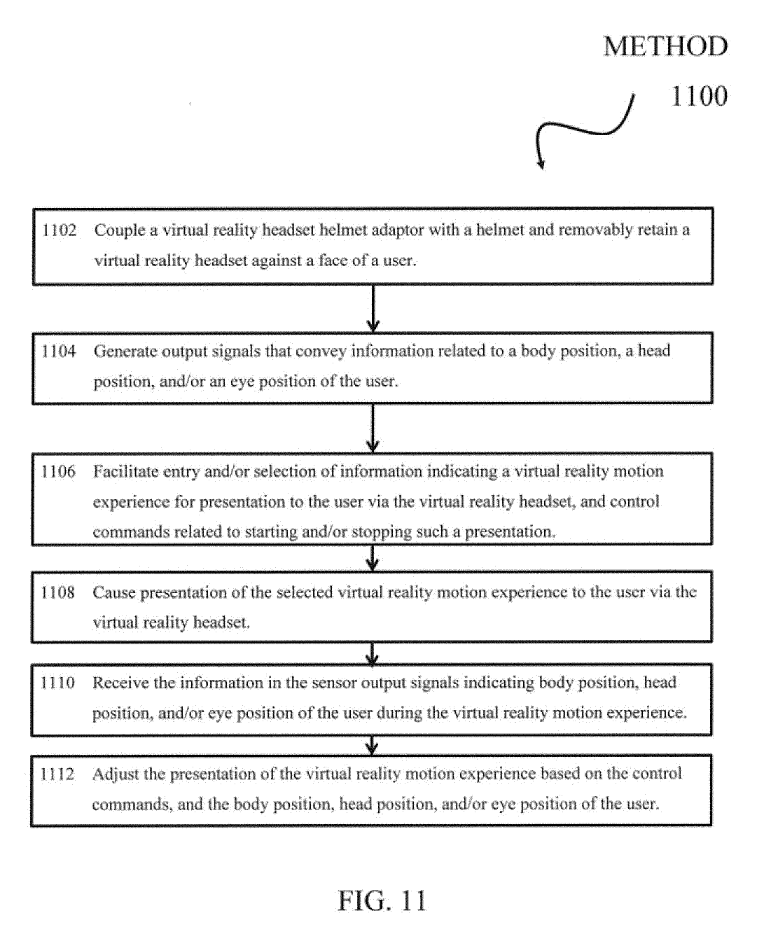

FIG. 9-11 illustrate methods 900, 1000, and 1100 for securing a virtual reality headset (FIG. 9 and method 900) and virtual reality motion simulation methods (FIG. 10-11 and methods 1000 and 1100). The operations of methods 900, 1000, and 1100 presented below are intended to be illustrative. In some embodiments, methods 900, 1000, and 1100 may be accomplished with one or more additional operations not described, and/or without one or more of the operations discussed. Additionally, the order in which the operations of methods 900, 1000, and 1100 are illustrated in FIG. 9-11 and described below is not intended to be limiting.

In some embodiments, methods 900, 1000, and/or 1100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 900, 1000, and/or 1100 in response to instructions stored electronically on an electronic storage medium. The one or more processing devices may include one or more devices configured through hardware, firmware, and/or software to be specifically designed for execution of one or more of the operations of methods 900, 1000, and/or 1100.

Referring to FIG. 9 and method 900, at an operation 902, a headset holder may be coupled with a helmet using an anchor strap, an anchor bracket, and/or other components. In some embodiments, operation 902 comprises coupling the headset holder with the helmet using the anchor strap, wherein the anchor strap may be coupled to a first side of the headset holder at or near a first end of the anchor strap. The anchor bracket may be coupled to a corresponding first side of the helmet. The anchor bracket may be configured to receive and engage a second end of the anchor strap to anchor the headset holder to the helmet via the anchor strap. In some embodiments, operation 902 may include forming a hole in a visor of the helmet, and coupling the headset holder with the hole formed in the visor of the helmet. In some embodiments, operation 902 may be performed by a headset holder, a helmet, an anchor strap, and/or an anchor bracket the same as or similar to headset holder 502, helmet 110, anchor strap 504, and/or anchor bracket 506 (shown in FIG. 5-6 and described herein).

At an operation 904, a second side of the headset holder may be removably coupled to the helmet using a tightening strap, a tightening bracket, a tightener, and/or other components. The tightening strap may be configured to removably couple with the second side of the headset holder at or near a first end of the tightening strap. The tightening bracket may be coupled to a corresponding second side of the helmet and configured to receive and engage a second end of the tightening strap. The tightener may be coupled to the second side of the headset holder and configured to be operated by the user to removably couple the tightening strap with the second side of the headset holder. The user may cause the tightening strap to pass through the tightener in a tightening direction such that the headset holder to engages the virtual reality headset and retains the virtual reality headset against the face of the user when the user wears the helmet and the virtual reality headset. In this way the virtual reality images displayed by the virtual reality headset may remain viewable by the user when the user wears the helmet and the virtual reality headset. In some embodiments, operation 904 may be performed by a tightening strap, a tightening bracket, and a tightener the same as or similar to tightening strap 508, tightening bracket 510, and tightener 512 (shown in FIG. 5-6 and described herein).

In some embodiments, operations 902 and/or 904 may include surrounding an outer edge of the virtual reality headset when the headset holder retains the virtual reality headset against the face of the user to support the virtual reality headset in alignment with eyes of the user. Surrounding the outer edge may be performed with an internal structural member and/or other components of the headset holder. The internal structural member may comprise a fracture-resistant frame and/or other components. In some embodiments, operations 902 and/or 904 may include covering the internal structural member with a stretchable fabric and/or other materials coupled to the internal structural member such that the stretchable fabric engages the virtual reality headset to press the headset against the face of the user when the headset holder is tightened. In some embodiments, operations 902 and/or 904 may include facilitating incremental tightening of the virtual reality headset against the face of the user with a ratchet mechanism formed by the tightener and the tightening strap, and prevention of the tightening strap from passing through the tightener in a direction opposite the tightening direction, unless released by the user via a release mechanism included in the tightener.

Referring to FIG. 10 and method 1000, at an operation 1002, entry and/or selection of information indicating a virtual reality motion experience for presentation to a user is facilitated. Operation 1002 may include facilitating entry and/or selection of information indicating the virtual reality motion experience for presentation to the user via a virtual reality headset worn by the user. Operation 1002 may further include facilitating entry and/or selection of control commands related to starting and/or stopping such a presentation. The entry and/or selection of information may be performed by an operator using an operator control system that is located remotely from the virtual reality headset and/or other systems. In some embodiments, operation 1002 may include presenting other images, scenes, motion experiences, branded focus screens for different wind tunnels, advertisements comprising video, images, text, and/or other information, etc. to the user. In some embodiments, operation 1002 is performed by one or more processors similar to and/or the same as processors 410 (shown in FIG. 4 and described herein).

At an operation 1004, presentation of the selected virtual reality motion experience to the user with the virtual reality headset may be caused. In some embodiments, operation 1004 is performed by one or more processors the same as or similar to processors 410 (shown in FIG. 4 and described herein).

At an operation 1006, information may be received from sensor output signals indicating body position, eye position, head position, physiological information, and/or other information related to the user during the virtual reality motion experience. In some embodiments, operation 1006 is performed by one or more processors the same as or similar to processors 410 (shown in FIG. 4 and described herein).

At an operation 1008, the presentation of the virtual reality motion experience may be adjusted based on control commands, and the body position, head position, and/or eye position of the user. In some embodiments, operation 1008 is performed by one or more processors the same as or similar to processors 410 (shown in FIG. 4 and described herein).

In some embodiments, operations 1002-1008 may include presenting the virtual reality motion experience to a plurality of users on a plurality of virtual reality headsets worn by the users, and individually controlling the virtual reality motion experience for specific ones of the users based on information in output signals from sensors associated with the specific ones of the users such that the virtual reality motion experience is coordinated across the plurality of virtual reality headsets worn by the plurality of users. In some embodiments, operations 1002-1008 may include facilitating selection of the virtual reality motion experience and selection of individual ones of the plurality of virtual reality headsets for presentation of the virtual reality motion experience using the operator control system. The operator control system may be located remotely from the plurality of virtual reality headsets. In some embodiments, operations 1002-1008 may include displaying the virtual reality motion experience for one or more of the plurality of users to the operator via the operator control system. In some embodiments, operations 1002-1008 may include wirelessly communicating with the virtual reality headsets via an open source Paho library, an AWS-IOT client, an open source messaging system, an internet messaging protocol, and/or other resources. The open source messaging system may comprise the internet messaging protocol (e.g., an MQTT broker) and/or other open source messaging systems, for example.

Referring to FIG. 11 and method 1100, at an operation 1102, a virtual reality headset helmet adaptor may be coupled with a helmet and removably retain a virtual reality headset against a face of a user. In some embodiments, operation 1102 may be performed by one or more components similar to and/or the same as helmet 110, headset holder 502, anchor strap 504, anchor bracket 506, tightening strap 508, tightening bracket 510, and/or tightener 512 (shown in FIG. 5-6 and described herein).

At an operation 1104, output signals that convey information related to a body position, a head position, an eye position, and/or other physiological parameters (e.g., heart rate, etc.) of the user may be generated. In some embodiments, operation 1104 may be performed by one or more sensors the same as or similar to sensors 240 (shown in FIG. 2 and described herein).

At an operation 1106, a processor may facilitate entry and/or selection of information indicating a virtual reality motion experience for presentation to the user via the virtual reality headset, and control commands related to starting and/or stopping such a presentation. In some embodiments, operation 1106 may include presenting other images, scenes, motion experiences, branded focus screens for different wind tunnels, advertisements comprising video, images, text, and/or other information, etc. to the user. In some embodiments, operation 1106 is performed by one or more processors the same as or similar to processors 410 (shown in FIG. 4 and described herein).

At an operation 1108, presentation of the selected virtual reality motion experience to the user via the virtual reality headset may be caused. In some embodiments, operation 1108 is performed by one or more processors the same as or similar to processors 410 (shown in FIG. 4 and described herein).

At an operation 1110, the information in the sensor output signals indicating body position, head position, eye position, and/or other physiological parameters (e.g., heart rate, etc.) of the user during the virtual reality motion experience may be received. In some embodiments, operation 1110 is performed by one or more processors the same as or similar to processors 410 (shown in FIG. 4 and described herein).

At an operation 1112, the presentation of the virtual reality motion experience may be adjusted based on the control commands, and the body position, head position, and/or eye position of the user, the other physiological parameters, and/or other information. In some embodiments, operation 1112 is performed by one or more processors the same as or similar to processors 410 (shown in FIG. 4 and described herein).

In the descriptions above, phrases such as “at least one of ” or “one or more of ” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above is intended to mean, “based at least in part on,” such that an unrecited feature or element is also permissible.

The embodiments set forth in the foregoing description do not represent all embodiments consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the embodiments described above can be directed to various combinations and sub-combinations of the disclosed features and/or combinations and sub-combinations of one or more features further to those disclosed herein. In addition, the logic flows described herein do not necessarily require the particular order shown, or sequential order, to achieve desirable results. The scope of the following claims may include other embodiments or embodiments. Moreover, the embodiments described above may be directed to various combinations and sub combinations of the disclosed features and/or combinations and sub combinations of several further features disclosed above. In addition, the logic flow depicted in the accompanying figures and/or described herein does not require the particular order shown, or sequential order, to achieve desirable results. Other embodiments may be within the scope of the following claims. Furthermore, the specific values provided in the foregoing are merely examples and may vary in some embodiments.

It is also noted herein that while the above describes example embodiments of the invention, these descriptions should not be viewed in a limiting sense. Rather, there are several variations and modifications which may be made without departing from the scope of the present invention as defined in the appended claims.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A virtual reality headset helmet adaptor system comprising:
a headset holder configured to couple with a helmet and removably retain a virtual reality headset against a face of a user such that virtual reality images displayed by the virtual reality headset remain viewable by the user when the user wears the helmet and the virtual reality headset;
an anchor strap coupled to a first side of the headset holder at or near a first end of the anchor strap;
an anchor bracket coupled to a corresponding first side of the helmet and configured to receive and engage a second end of the anchor strap to anchor the headset holder to the helmet via the anchor strap;
a tightening strap configured to removably couple with a second side of the headset holder at or near a first end of the tightening strap;
a tightening bracket coupled to a corresponding second side of the helmet configured to receive and engage a second end of the tightening strap; and
a tightener coupled to the second side of the headset holder configured to be operated by the user to removably couple the tightening strap with the second side of the headset holder by causing the tightening strap to pass through the tightener in a tightening direction such that the headset holder engages the virtual reality headset and retains the virtual reality headset against the face of the user when the user wears the helmet and the virtual reality headset.

2. The virtual reality headset adaptor system of claim 1, wherein the headset holder comprises:
an internal structural member comprising a fracture-resistant frame configured to surround an outer edge of the virtual reality headset when the headset holder retains the virtual reality headset against the face of the user to support the virtual reality headset in alignment with eyes of the user; and
a stretchable fabric coupled to the internal structural member that covers the internal structural member such that the stretchable fabric engages the virtual reality headset to press the headset against the face of the user when the headset holder is tightened.

3. The virtual reality headset adaptor system of claim 1, wherein the tightener and the tightening strap comprise a ratchet mechanism that facilitates incremental tightening of the virtual reality headset against the face of the user, and prevention of the tightening strap from passing through the tightener in a direction opposite the tightening direction, unless released by the user via a release mechanism included in the tightener.

4. The virtual reality headset adaptor system of claim 1, wherein the headset holder is configured to couple with a hole formed in a visor of the helmet.

5. The virtual reality headset adaptor system of claim 1, wherein the virtual reality headset comprises a flexible display screen.

6. A virtual reality motion simulation system, the system comprising one or more hardware processors configured by machine readable instructions to:
facilitate entry and/or selection of information indicating a virtual reality motion experience for presentation to a user via a virtual reality headset worn by the user, and control commands related to starting and/or stopping such a presentation, wherein the entry and/or selection of information is performed by an operator using an operator control system that is located remotely from the virtual reality headset;
cause presentation of the selected virtual reality motion experience to the user via the virtual reality headset;
receive information from sensor output signals indicating body position, head position, and/or eye position of the user during the virtual reality motion experience; and
adjust the presentation of the virtual reality motion experience based on the control commands, and the body position, head position, and/or eye position of the user.

7. The virtual reality motion simulation system of claim 6, wherein the one or more hardware processors are further configured to present the virtual reality motion experience to a plurality of users on a plurality of virtual reality headsets worn by the users, and individually control the virtual reality motion experience for specific ones of the users based on information in output signals from sensors associated with the specific ones of the users such that the virtual reality motion experience is coordinated across the plurality of virtual reality headsets worn by the plurality of users.

8. The virtual reality motion simulation system of claim 7, wherein the one or more hardware processors are configured to facilitate selection of the virtual reality motion experience and selection of individual ones of the plurality of virtual reality headsets for presentation of the virtual reality motion experience using the operator control system, the operator control system located remotely from the plurality of virtual reality headsets.

9. The virtual reality motion simulation system of claim 8, wherein the one or more hardware processors are configured to display the virtual reality motion experience for one or more of the plurality of users to the operator via the operator control system.

10. The virtual reality motion simulation system of claim 6, wherein the one or more hardware processors are configured to wirelessly communicate with the virtual reality headset via an open source Paho library or an AWS-IOT client, and an open source messaging system, the open source messaging system comprising an MQTT broker.

11. A virtual reality motion simulation system, the system comprising:
a virtual reality headset helmet adaptor configured to couple with a helmet and removably retain a virtual reality headset against a face of a user such that virtual reality images displayed by the virtual reality headset remain viewable with eyes of the user when the user wears the helmet and the virtual reality headset, the virtual reality headset helmet adaptor configured to be operated by the user to tighten the virtual reality headset against the face of the user;
one or more sensors configured to generate output signals that convey information related to a body position, a head position, a heart rate, and/or an eye position of the user; and
one or more hardware processors configured by machine readable instructions to:
facilitate entry and/or selection of information indicating a virtual reality motion experience for presentation to the user via the virtual reality headset, and control commands related to starting and/or stopping such a presentation, wherein the entry and/or selection of information is performed by an operator using an operator control system that is located remotely from the virtual reality headset;
cause presentation of the selected virtual reality motion experience to the user via the virtual reality headset;
receive the information in the sensor output signals indicating body position, head position, heart rate, and/or eye position of the user during the virtual reality motion experience; and
adjust the presentation of the virtual reality motion experience based on the control commands, and the body position, head position, heart rate, and/or eye position of the user.

12. A method for securing a virtual reality headset comprising:
coupling a headset holder with a helmet with an anchor strap coupled to a first side of the headset holder at or near a first end of the anchor strap, and an anchor bracket coupled to a corresponding first side of the helmet, the anchor bracket configured to receive and engage a second end of the anchor strap to anchor the headset holder to the helmet via the anchor strap; and
removably coupling a second side of the headset holder to the helmet using a tightening strap, a tightening bracket, and a tightener, wherein:
the tightening strap is configured to removably couple with the second side of the headset holder at or near a first end of the tightening strap,
the tightening bracket is coupled to a corresponding second side of the helmet and configured to receive and engage a second end of the tightening strap, and
the tightener is coupled to the second side of the headset holder and configured to be operated by the user to removably couple the tightening strap with the second side of the headset holder by causing the tightening strap to pass through the tightener in a tightening direction such that:
the headset holder engages the virtual reality headset and retains the virtual reality headset against the face of the user when the user wears the helmet and the virtual reality headset; and
virtual reality images displayed by the virtual reality headset remain viewable by the user when the user wears the helmet and the virtual reality headset.

13. The method of claim 12, further comprising:
surrounding an outer edge of the virtual reality headset when the headset holder retains the virtual reality headset against the face of the user to support the virtual reality headset in alignment with eyes of the user with an internal structural member of the headset holder comprising a fracture-resistant frame; and
covering the internal structural member with a stretchable fabric coupled to the internal structural member such that the stretchable fabric engages the virtual reality headset to press the headset against the face of the user when the headset holder is tightened.

14. The method of claim 12, further comprising facilitating incremental tightening of the virtual reality headset against the face of the user with a ratchet mechanism formed by the tightener and the tightening strap, and prevention of the tightening strap from passing through the tightener in a direction opposite the tightening direction, unless released by the user via a release mechanism included in the tightener.

15. The method of claim 12, further comprising forming a hole in a visor of the helmet, and coupling the headset holder with the hole formed in the visor of the helmet.

16. The method of claim 12, wherein the virtual reality headset comprises a flexible display screen.

17. A virtual reality motion simulation method, the method comprising:
facilitating entry and/or selection of information indicating a virtual reality motion experience for presentation to a user via a virtual reality headset worn by the user, and control commands related to starting and/or stopping such a presentation, wherein the entry and/or selection of information is performed by an operator using an operator control system that is located remotely from the virtual reality headset;
causing presentation of the selected virtual reality motion experience to the user via the virtual reality headset;
receiving information from sensor output signals indicating body position, eye position, and/or head position of the user during the virtual reality motion experience; and
adjusting the presentation of the virtual reality motion experience based on the control commands, and the body position, head position, and/or eye position of the user.

18. The method of claim 17, further comprising presenting the virtual reality motion experience to a plurality of users on a plurality of virtual reality headsets worn by the users, and individually controlling the virtual reality motion experience for specific ones of the users based on information in output signals from sensors associated with the specific ones of the users such that the virtual reality motion experience is coordinated across the plurality of virtual reality headsets worn by the plurality of users.

19. The method of claim 18, further comprising facilitating selection of the virtual reality motion experience and selection of individual ones of the plurality of virtual reality headsets for presentation of the virtual reality motion experience using the operator control system, the operator control system located remotely from the plurality of virtual reality headsets.

20. The method of claim 19, further comprising displaying the virtual reality motion experience for one or more of the plurality of users to the operator via the operator control system.

21. The method of claim 17, further comprising wirelessly communicating with the virtual reality headset via an open source Paho library or an AWS-IOT client, and an open source messaging system, the open source messaging system comprising an MQTT broker.

22. A virtual reality motion simulation method, the method comprising:
coupling a virtual reality headset helmet adaptor with a helmet and removably retaining a virtual reality headset against a face of a user such that virtual reality images displayed by the virtual reality headset remain viewable with eyes of the user when the user wears the helmet and the virtual reality headset, the virtual reality headset helmet adaptor configured to be operated by the user to tighten the virtual reality headset against the face of the user;
generating output signals that convey information related to a body position, a head position, and/or an eye position of the user;
facilitating entry and/or selection of information indicating a virtual reality motion experience for presentation to the user via the virtual reality headset, and control commands related to starting and/or stopping such a presentation, wherein the entry and/or selection of information is performed by an operator using an operator control system that is located remotely from the virtual reality headset;
causing presentation of the selected virtual reality motion experience to the user via the virtual reality headset;
receiving the information in the sensor output signals indicating body position, head position, and/or eye position of the user during the virtual reality motion experience; and
adjusting the presentation of the virtual reality motion experience based on the control commands, and the body position, head position, and/or eye position of the user.

23. The method of claim 22, wherein causing presentation of the selected virtual reality motion experience to the user via the virtual reality headset further comprises causing presentation of one or more video and/or image advertisements to the user before the presentation of the selected virtual reality motion experience begins.
